(19) United States
(12) Patent Application Publication
(10) Pub. No.: US 2024/0106761 A1
(43) Pub. Date: Mar. 28, 2024

(54) ADAPTIVE SCALING OF BUFFERS FOR COMMUNICATION SESSIONS

(71) Applicant: Citrix Systems, Inc., Fort Lauderdale, FL (US)

(72) Inventors: Rakesh Jha, Sunnyvale, CA (US); Sridharan Rajagopalan, Pompano Beach, FL (US); Georgy Momchilov, Parkland, FL (US)

(73) Assignee: Citrix Systems, Inc., Fort Lauderdale, FL (US)

(21) Appl. No.: 17/954,911

(22) Filed: Sep. 28, 2022

(51) Int. Cl. H04L 47/283

(52) U.S. Cl. CPC H04L 47/283

(57) ABSTRACT

Described embodiments provide systems and methods for determining a scale for buffers of a session. A device may identify a round trip time (RTT) of a session with a client for which one or more of a plurality of buffers are provided. The device may detect an indication in advance of an activity on the client to access through the session. The device may determine, responsive to detecting the indication, a scale based at least on a type of the activity. The device may set a number for the plurality of buffers to provide for the session in accordance with the scale and the RTT.

### FIELD OF THE DISCLOSURE

The present application generally relates to network communications. In particular, the present application relates to systems and methods for determining scales for buffers to provide sessions.

### BACKGROUND

In a networked environment, a client may communicate with a server via a session to access resources hosted thereon. Various network-related factors may affect the performance of the session and thus the user's experience with the session.

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

Network throughput may be the rate of successful data delivery over a communication channel, and may measure amount of data sent per second. The data sent between a client and a server can generally be classified into two types: (1) interactive (or real-time) data and (2) non-interactive data. The performance specifications for successful delivery of these types of data may be at times conflicting. In particular, interactive data may time critical, with any delay in delivering a packet adversely impacting user interactivity negatively (e.g., audio, video, or graphic updates). In contrast, non-interactive data (e.g., file transfer or a print job) can be accumulated and sent together for best throughput. Interactive data may depend on how fast a data can be delivered, whereas non-interactive data may depend on how effectively large amounts of data can be delivered.

Given the dichotomy in specifications, the performance can also be divided into two broad categories. The performance considerations for interactive data may include, for example: the time between user interaction (e.g., a mouse click) and the corresponding graphics updates; a responsiveness of the session to user interaction; and a quality of multimedia content (e.g., video), including lag between an interaction and response in the content, and buffering of the content, among others. The performance considerations non-interactive data may include file transfer or copy speed from the server to the client.

When the amount of in-flight data through the network is high, the network throughput may also be high, sending more data per second. The high network throughput may cause a delay in delivering packets related interactive data, thereby leading to poor user experience due to jitter or inconsistent graphics (or user interface) updates, but achieve higher throughput for data-oriented streams. In sum, interactivity may suffer, while non-interactive performance may improve. Conversely, when the amount of in-flight data through the network is low, interactivity may improve while hindering non-interactive performance.

Many applications may use both types of data and thus rely on performances to be optimized, depending on the operation (e.g., typing and scrolling versus saving files) being carried out. A transport for the communication of the data may be optimized to satisfy all types of operations on the applications. Due to the counter intuitive nature of interactive and non-interactive traffic, it may be difficult to optimize for consideration for both types of traffic. The goal may be to achieve the best performance for the activity occurring at that point in the session with minimal impact to the other activities happening in the background.

Session Reliability and fast recovery from short network disruptions may rely on session or application layer buffering of the data at the sender for guaranteed delivery across such disruptions using re-establishment of underlying transport. This may specify buffering of packets at sending endpoint, irrespective of any intermediary, until receiving endpoint acknowledges reception of the data. Session buffer pools may control the availability of these required buffers for reliably sending session data and the count of buffers in pools may be moderated by session for optimal performance.

Under one approach, a stack for processing communications for a communications protocol for providing virtual desktop sessions (e.g., Remote Desktop Session (RDP), Independent Computing Architecture (ICA), or high definition experience (HDX) protocols) may scale the network throughput without reliance on what activity the user is performing. The transport may attempt to maximize the throughput without causing any impact to user interactivity. When the interactivity measure starts falling, the transport may scale back on the throughput. The transport may also have a conservative increase cycle to keep interactivity impact to minimum. In this fashion, the approach may be reactive and scale slowly to permissible levels.

In this approach, however, the transport may monitor the demand and reactively take some time to scale available buffers required for the ideal throughput. The optimal throughput may vary according to the operation at hand. For instance, during file copy, the optimal throughput may be of higher order than during video playback. Under the approach, methods of scaling buffers may be reactive to the operation, in that the scaling begins after the operation (e.g., file copy) has begun. Furthermore, the transport may utilize available the available buffers until the scaling algorithm slowly increases the available buffers without impacting interactivity, even though file copy should be higher priority to the user at the instant than interactive data. The buffer scaling may be also capped for better interactivity. To illustrate, under this approach, if multiple file copies are performed consecutively, the first copy operation may always consume more time and the last copy operation may be the quickest with a gradual decrease in times from the first to the last. Additionally, following the same pattern when the copies are complete, the scaling down of the buffer may be gradual.

To address these and other technical challenges, indications of the activity in advance of the occurrence of the activity may be factored in the scaling of the buffers. Using hooks or data from virtual channels on an agent on a client, the activity in a virtual desktop or application session may be gathered. The activity may include, for example, a start and end of a file copy, a bulk transfer of data, a print command, and interactions with graphical user interface elements, among others. Indications (sometimes herein referred to as hints) of the activity may be relayed to the stack for scaling available buffers.

By using these indications, the optimized performance may be achieved from the start for various activities on the client. In addition, identification of application window layouts to distinguish foreground and background activities may be used to further improve to the indication to optimize the buffers. When bulk transfer starts (e.g., start of file copy), a notification or cue may be conveyed to the processing stack to signal the beginning of the operation. The processing stack in turn may anticipate the bulk data transfer in response to the notification, and may proactively scale the buffers up for better throughput under the bounds of interactivity. On the other hand, when an interactive task (e.g., typing, scrolling, and moving windows) is detected, the processing system can scale down the buffers.

In this manner, performance of the session may be improved by detecting an indication of activities to occur on an application. The buffers may be scaled up or down for short-term activities to optimize network throughput to make the activity efficient during the time. A layer of reliability over the transport can utilize the optimization process to improve the performance for selective phases of the session.

Aspects of the present disclosure are directed to systems, methods, and non-transitory computer readable medium for determining a scale for buffers of a session. A device may identify a round trip time (RTT) of a session with a client for which one or more of a plurality of buffers are provided. The device may detect an indication in advance of an activity on the client to access through the session. The device may determine, responsive to detecting the indication, a scale based at least on a type of the activity. The device may set a number for the plurality of buffers to provide for the session in accordance with the scale and the RTT.

In some embodiments, the device may detect the indication in advance of a start of a user interactive activity on the client. In some embodiments, the device may determine the scale to decrease the number of the plurality of buffers to provide. In some embodiments, the device may detect the indication in advance of an end of a user interactive activity on the client. In some embodiments, the device may determine the scale to increase the number of the plurality of buffers to provide, responsive to a deviation of the RTT from a reference value exceeding a threshold.

In some embodiments, the device may detect the indication in advance of a start of a bulk data transfer through the session. In some embodiments, the device may determine the scale to increase the number of the plurality of buffers to provide. In some embodiments, the device may detect the indication in advance of an end of a bulk data transfer through the session. In some embodiments, the device may determine the scale to decrease the number of the plurality of buffers to provide, responsive to a deviation of the RTT from a reference value exceeding a threshold.

In some embodiments, the device may detect the indication in advance of a plurality of activities on the client. In some embodiments, the device may identify, from the plurality of activities, the activity to be performed in a foreground process. In some embodiments, the device may determine the scale in accordance with the type of the activity to be performed in the foreground process.

In some embodiments, the device may detect the indication in advance of a plurality of activities on the client. In some embodiments, the device may identify, from the plurality of activities, the activity to be performed in a foreground process and a second activity to be performed in a background process. In some embodiments, the device may determine the scale in accordance with a policy identifying a plurality of priorities for the foreground process and the background process.

In some embodiments, the device may detect the indication in advance of a multimedia communications via the client. In some embodiments, the device may determine the scale using at least one of: a network metric of the session, characteristics of content in the multimedia communications, or measurements from a plurality of sessions with multimedia content. In some embodiments, the device may modify, between a start and an end of the activity, the number of the plurality of buffers to provide to the session in accordance with a comparison of the RTT with a threshold.

In some embodiments, the device may determine, responsive to detecting the indication, whether to set the number of the plurality of buffers based at least on the RTT of the session. In some embodiments, the device may provide, prior to detecting the indication, a second number of the plurality of buffers based at least on the RTT.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a block diagram of an embodiment of a system for providing or using a virtual channel to provide insights, according to an illustrative embodiment;

FIG. 6 is a diagram of an embodiment of a system and method for providing or using a virtual channel to provide insights, according to an illustrative embodiment;

FIG. 7 is a block diagram of an embodiment of a system for App Flow data points collection and transmission, according to an illustrative embodiment;

FIG. 8 is a block diagram of an embodiment of a system for determining scales for buffers for sessions in accordance with an illustrative embodiment;

FIG. 9A is a block diagram of a process of initializing buffers for sessions in the system for determining scales in accordance with an illustrative embodiment;

FIG. 9B is a block diagram of a process of scaling buffers in response to indications of initiation of activities in the system for determining scales in accordance with an illustrative embodiment;

FIG. 9C is a block diagram of a process of scaling buffers during performance of activities in the system for determining scales in accordance with an illustrative embodiment;

FIG. 9D is a block diagram of a process of scaling buffers in response to indications of termination of activities in the system for determining scales in accordance with an illustrative embodiment;

FIG. 10 is a communication diagram of an embodiment of a process for determining scales for buffers for sessions between a server-side agent and a client-side agent in accordance with an illustrative embodiment;

FIG. 11 is a flow diagram of an embodiment of a method of determining scales for buffers for sessions prior to detecting activities on clients in accordance with an illustrative embodiment;

FIG. 12A is a flow diagram of an embodiment of a method of determining scales for buffers for sessions when detecting an indication of a user interactive activity in accordance with an illustrative embodiment;

FIG. 12B is a flow diagram of an embodiment of a method of determining scales for buffers for sessions when detecting an indication of a bulk data transfer in accordance with an illustrative embodiment;

FIGS. 13A-13C are flow diagrams of an embodiment of a method of determining scales for buffers for sessions in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for virtualizing an application delivery controller;
Section D describes embodiments of systems and methods for providing a clustered appliance architecture environment;
Section E describes embodiments of systems and methods for providing and using a virtual channel to provide insights; and
Section F describes embodiments of systems and methods for determining scales for buffers for sessions.

### A. Network and Computing Environment

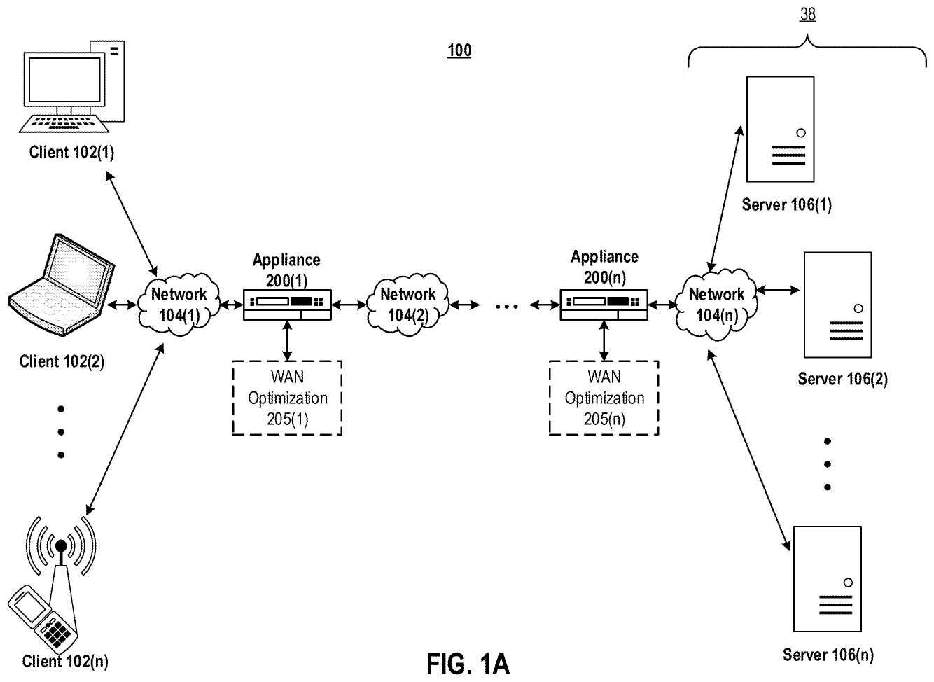

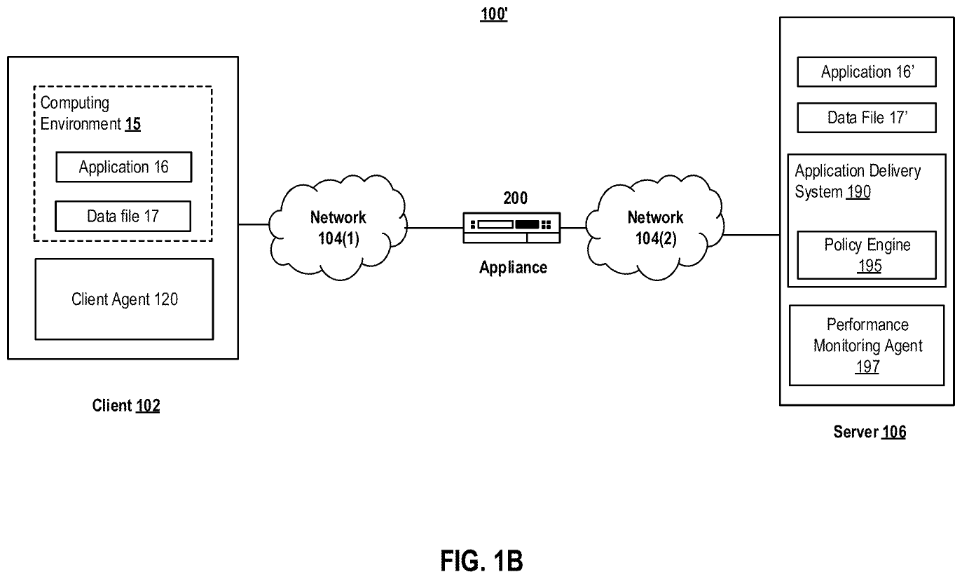

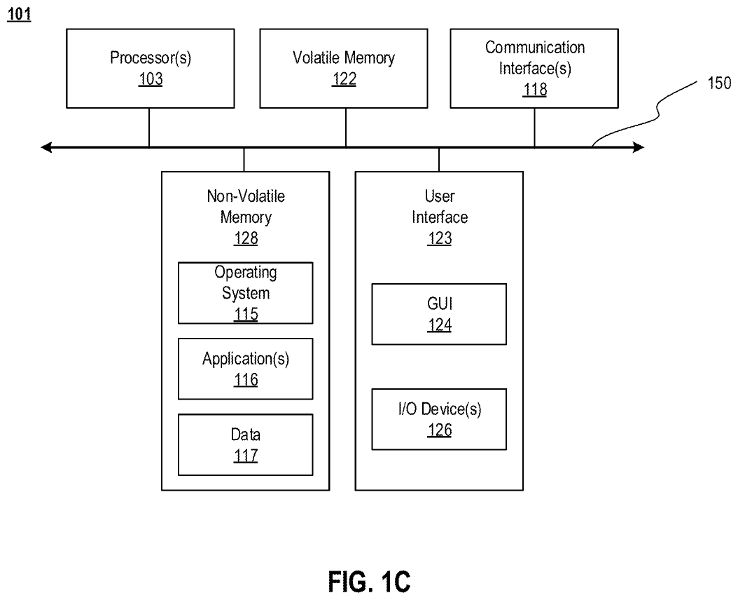

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as NetScaler® products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as CloudBridge® products sold by Citrix Systems, Inc. of Fort Lauderdale, FL.

Referring to FIG. 1B, an example network environment 100′ for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered to the client 102 via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as XenApp® or XenDesktop®.

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 102 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management, and reporting, for example by software, hardware or a combination thereof. Performance monitoring may include one or more agents for performing monitoring, measurement, and data collection activities on clients 102 (e.g., client agent 120), servers 106 (e.g., agent 197) or an appliances 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as EdgeSight by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

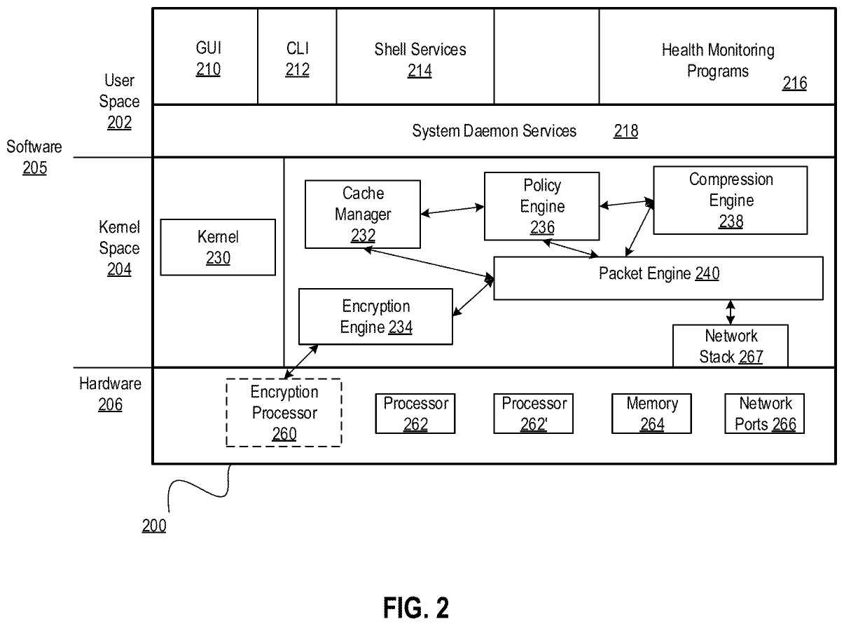

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer for queuing one or more network packets for transmission by appliance 200.

Kernel space 204 may include cache manager 232, packet engine 240, encryption engine 234, policy engine 236, and compression engine 238. In other words, one or more of processes 232, 240, 234, 236, and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reduce the access time of the data. In some embodiments, the cache manager 232 may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236, and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include programs, services, tasks, processes or executable instructions to support interaction with appliance 200 by a user via the GUI 210 and/or CLI 212.

Health monitor 216 monitors, checks, reports, and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine whether a program, process, service or task is active and currently running, check status, error or history logs provided by any program, process, service or task to determine any condition, status or error with any portion of appliance 200. Additionally, health monitor 216 may measure and monitor the performance of any application, program, process, service, task, or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layers connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication, and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

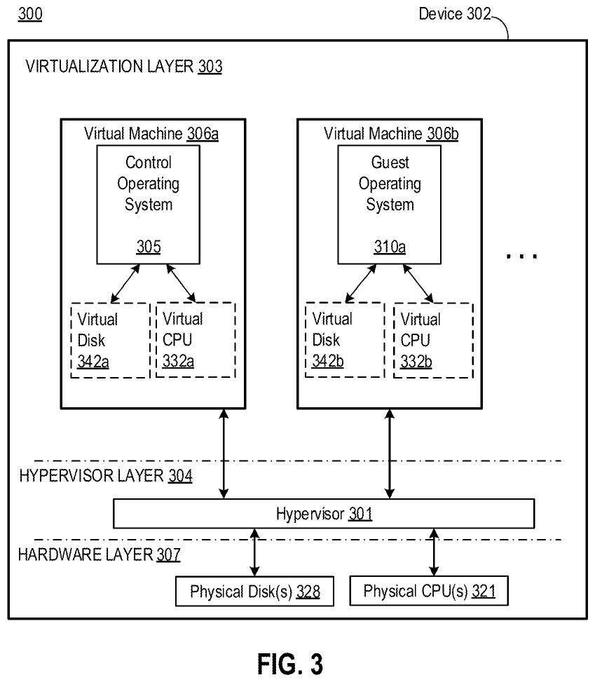

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical CPU(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a XEN hypervisor, for example as provided by the open source Xen.org community. In an illustrative embodiment, device 302 executing a hypervisor that creates a virtual machine platform on which guest operating systems may execute is referred to as a host server. In such an embodiment, device 302 may be implemented as a XEN server as provided by Citrix Systems, Inc., of Fort Lauderdale, FL.

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling, and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2, and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load, or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

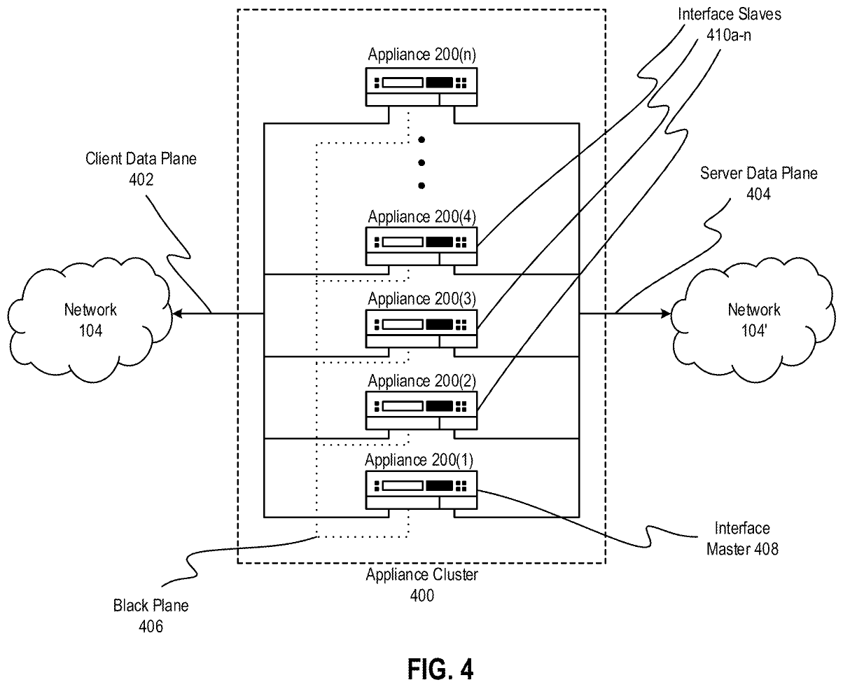

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a client-side network 104 via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104′ via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Providing and Using a Virtual Channel to Provide Insights

Described herein are systems and methods for providing insights or metrics in connection with provisioning applications and/or desktop sessions to end-users. Network devices (e.g., appliances, intermediary devices, gateways, proxy devices or middle-boxes) such as Citrix Gateway and Citrix software-defined wide area network (SD-WAN) devices can gather insights such as network-level statistics. Additional insights (e.g., metadata and metrics) associated with virtual applications and virtual desktops can be gathered to provide administrators with comprehensive end-to-end real-time and/or historical reports of performance and end-user experience (UX) insights. In some embodiments, to obtain the insights, the network devices may have to perform deep parsing of virtualization and other protocols such as Citrix independent computing architecture (ICA), remote desktop protocol (RDP), or Citrix high definition experience (HDX), along with some or all associated virtual channels (VCs).

This deep parsing can demand or entail knowledge of all underlying protocol details, and can be resource intensive. The effort for a network device to deeply parse, decrypt and/or decompress traffic (e.g., HDX traffic) can hurt the scalability of the network device and can significantly increase the cost of supporting (e.g., HDX specific) insights. These can be memory and CPU intensive operations that directly affect the number of connections (e.g., ICA connections) that a network device (e.g., Citrix Gateway or SD-WAN appliance) can support at a time. Deep parsing of such traffic can be a memory and CPU intensive operation, mainly because of the stateful decompression of the ICA stream. “Stateful” can refer to maintaining, tracking, keeping, storing and/or transitioning of state(s) across connections, sessions, time, and/or operations, for example.

To address these and other challenges, the present disclosure provides embodiments of methods and systems for delivering insights of a virtual session to a network device in a real-time, scalable and/or extensible manner (e.g., without deep parsing by a network device). In some embodiments, a separate or independent VC (sometimes referred to as an App Flow VC) can be established across or between a client-side agent (e.g., desktop virtualization client), network device(s), and a server-side agent (e.g., VDA) for the transmission of insights (e.g., virtualization session insights). The App Flow VC can be negotiated between these entities (e.g., between the desktop virtualization client, network appliances, and VDA). The App Flow VC can facilitate scalable and extensible processing of insights. The App Flow VC can remain non-interleaved with other VCs in a HDX/ICA stream, and the stream can be uncompressed to facilitate access to and parsing of the App Flow VC. Such simple parsing consumes significantly lower levels of resources, and improves the operation of the network device by allowing more resources of the network device to perform any other functions, such as to process a larger number of connections (e.g., ICA connections) at a given time. Even if a larger number of connections is not necessary, lower consumption of CPU resources for instance results in lower power consumption (e.g., lower energy wastage to obtain similar insights) and/or heat generation, as compared with deep parsing. Hence, the present system and methods allow for substantive improvements in the operation of system components such as network devices (e.g., SD-WAN and gateway devices).

Further, embodiments of the present methods and system can improve the HDX/ICA platform in addition ways. For example, embodiments of the present methods and system can provide or support state transition of App Flow insights or metrics during network device failover (e.g., high-availability failover), hence improving operation during such failover. Certain embodiments of the present methods and system provide or support efficient identification and prioritization of Multi-stream ICA (MSI) HDX streams, which reduces resources to access and process data from such streams. Some embodiments of the present methods and system provide or support layer 7 (L7, application layer) latency calculation and communication independent of server processing time. Some embodiments of the present methods and system provide or support L7 latency calculation and communication between multiple network devices. Hence, these solutions can provide metrics that more accurately characterizes the health and performance of specific network components, segments, or connections.

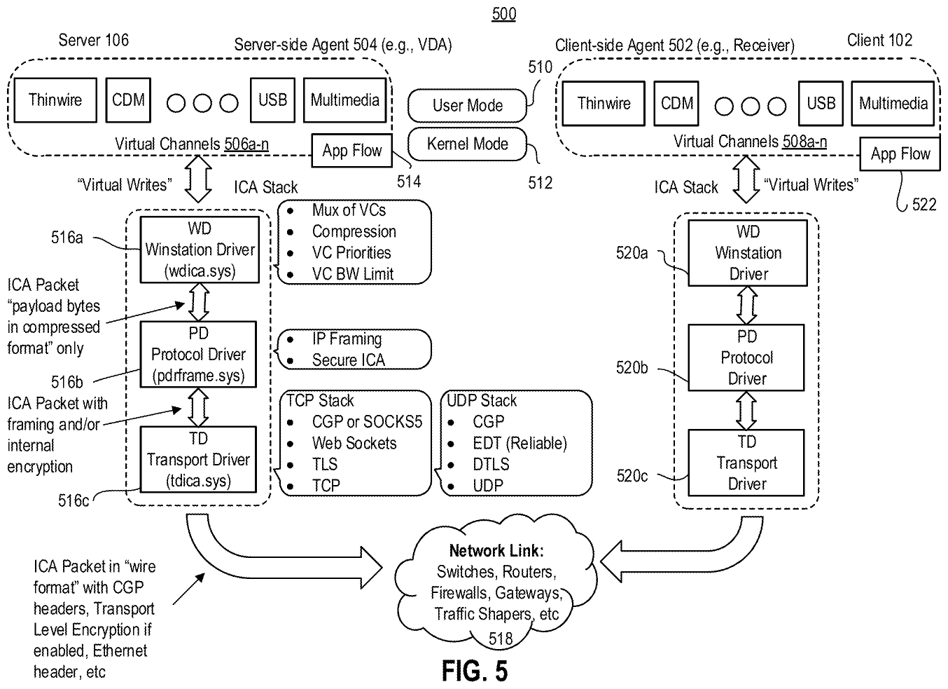

In an ICA or HDX configuration for instance, VCs can support a remote computing experience at a client 102, by providing access to one or more applications and/or remote desktops hosted on a server 106. As shown in FIG. 5, VCs can be established using a server-side agent 504 and a client-side agent 502. As illustrated in FIG. 5, the system 500 can include a client 102 with a client-side agent 502 (e.g., Workspace App), a server 106 with a server-side agent 504 (e.g., VDA), ICA stacks on each of the client 102 and the server 106, that supports the HDX session via a network link. Each of the ICA stacks 516a—n can include a WinStation driver (WD) 516a, a protocol driver (PD) 516b, and/or a transport driver (TD) 516c, each involving one or more corresponding protocols.

VCs can support communications and functionalities between the client 102 and the server 106, in provisioning an application or desktop via remote delivery to the client 102. Virtual channels can provide a secure way for an application running on the server 106 to communicate with the client 102 or the client-side environment. Each virtual channel can support communications for supporting or enabling one or more functionalities of the application or desktop, such as graphics, disks, COM ports, LPT ports, printers, audio, video, smart card, and so on, so that these functionalities are available across the client 102 and the server 106. Some virtual channels can be loaded or established in user mode 510, and some others can be loaded or established in kernel mode 512. Virtual channels established in the user mode 510 may have limited access to the functionalities of the client 102 or the server 106 (e.g., those allocated to the application for the virtual channel). Conversely, virtual channels established in the kernel mode 512 may have full or more expansive access to the functionalities of the client 102 or the server 106 (e.g., besides those allocated to the application). A client virtual channel, for example, can be routed through a WinStation driver 520a (e.g., in the server-side ICA stack 520a-n), and can be polled or accessed on the client-side by a corresponding WinStation driver 516a (e.g., in the client-side ICA stack 516a-n). On the client side, virtual channels can correspond to virtual drivers each providing a specific function. The virtual drivers can operate at the presentation layer protocol level for instance (or another protocol level). There can be a number of these protocols active at any given time by multiplexing channels that are provided by for instance the WinStation protocol layer (or WinStation driver). Multiple virtual channels can be combined or multiplexed within a provisioning session (e.g., an ICA/HDX session or traffic stream).

Virtual channels can be created by virtualizing one or more “physical” channels, each virtualized into one or more virtual channels. For example, several virtual channels may be identified separately and can carry different types of communications, but may share the same port corresponding to a physical channel. The use of virtual channels can allow sharing or data multiplexing on a single non-virtual channel to support multiple streams of information. One or more virtual channels may operate to communicate presentation layer elements from the server 106 to the client device 102. Some of these virtual channels may communicate commands, function calls or other messages from the client device 102 to an application or a remote desktop's operating system. These messages may be used to control, update or manage the operation and display of the application or desktop.

By way of example, a client-side agent 502 may receive, from a server-side agent 504 via a provisioning (e.g., ICA, RDP, HDX) session, data associated with a remote desktop environment generated on a server 106 (e.g., a Citrix Virtual Desktops server). In some embodiments, the client-side agent 502 may be provided as a dynamically linked library component for example, that receives window creation and window process data from the server-side agent 504 for use in displaying a local version of a window generated on the server 106. In some embodiments, the client-side agent 502 may receive data such as window attribute data over one or more connections. The one or more connections may be multiplexed into one or more virtual channels. Such multiplexing may allow for different virtual channels to have different bandwidth limits or different priorities, while still being part of a single transport layer connection. This can reduce the transport layer overhead required and provide for SSL or VPN tunnel capability, while still allowing per-channel compression, buffering, and/or management of communication priority between the client-side agent 502 and the server-side agent 504. The virtual channels may be dedicated to specific content types or purposes. For example, a first high-priority virtual channel may be dedicated to transmission of application output data, while a second low-priority virtual channel may be dedicated to transmission of taskbar thumbnail images. A plurality of virtual channels can be used for communicating one or more types of application data (e.g., audio, graphics, metadata, printer data, disk data, smart card data, and so on). For instance, some types of application data can each be conveyed or communication via a dedicated virtual channel within the provisioning session, and/or certain types of application data can each be conveyed or communication to the intermediary device by sharing one or more virtual channels.

In a HDX session for delivering an application or desktop (e.g., Citrix DaaS™ (formerly Citrix Virtual Apps and Desktops, XenApp® or XenDesktop®)), the protocol exchange between a client-side agent (e.g., Citrix Workspace App) and a server-side agent (e.g., Citrix Virtual Apps and Desktops virtual delivery agent (VDA)) can involve multiple protocols including a core ICA protocol, and protocols for VCs representing various technologies, such as graphics, multimedia, printing, drive mapping, windowing, user input, etc. Deep parsing (e.g., decompression, decoding, decryption, and/or de-interleaving) of such virtualization protocols and/or VC data streams can consume significant processing resources and greatly limit the scalability of network devices. For instance, network devices (e.g., Citrix Gateway and SD-WAN) can deeply parse ICA traffic flowing through a network, having one or more protocols such as transmission control protocol (TCP) or transport layer security (TLS), enlightened data transport (EDT) or datagram transport layer security (DTLS) or user datagram protocol (UDP), common gateway protocol (CGP), ICA framing, custom ICA encryption (e.g. secure ICA), ICA protocol itself (e.g., including compression, such as stateful context-based compression) and de-interleaving of individual core ICA or VC data streams, and the individual VC protocols in order to gather various information or insights from a HDX session for instance.

In addition to HDX, RDP or ICA based sessions, other types of communications sessions are contemplated that can include various channels or connections of data streams (e.g., with features similar to virtual channels), and may involve various corresponding protocols. Insights, metrics, analytics, statistics, and/or other information (hereafter sometimes generally referred to as insights) relating to the communication session can be used to determine and/or improve user experience and the overall health of the infrastructure of the communications session (e.g., Citrix Virtual Apps and Desktops infrastructure), and the applications (e.g., Microsoft Office applications, remote desktop application) being delivered using the infrastructure. The insights can be combined with other network-health analysis performed by network devices, and/or processed and/or used by the network devices (e.g. Citrix Gateway or Citrix SD-WAN), to for instance adapt or improve certain operation(s). In addition, such collective insights may be provided to a management and triaging utility (e.g. Citrix Director), a management analytics service, or a third-party collector tool. The collective insights and/or these tools can allow administrators to view and analyze real-time client, host, and network latency metrics, historical reports and/or end-to-end performance data, and can allow the administrators to troubleshoot performance and network issues.

However, the effort for a network device to deeply parse, decrypt, and/or decompress traffic (e.g., HDX traffic) can hurt or limit the scalability of the network device and can significantly increase the cost of supporting (e.g., HDX specific) insights. These can be memory and CPU intensive operations that directly affect the number of connections (e.g., ICA connections) that a network device (e.g., Citrix Gateway or SD-WAN appliance) can support at a time. Deep parsing of such traffic can be a memory and CPU intensive operation, mainly because of the stateful decompression of the ICA stream. “Stateful” can refer to maintaining, tracking, keeping, storing, and/or transitioning of state(s) across connections, sessions, time, and/or operations, for example.

In some embodiments, adding additional insights for retrieval by a network device may entail updating one or more of the session protocols (e.g., the HDX protocols). Parsing multi-stream ICA (MSI) streams can further complicate the network device's parsing mechanism, logic, and/or methods. High-availability (HA) failovers from one network device to another can also be complicated by the process or requirement of transitioning very large and complex state between the devices in order to continue gathering insights. High-availability, for instance, can refer to a system being tolerant to failure, such as using hardware redundancy. In some embodiments, measuring the roundtrip latency between client-side and server-side agents (e.g., Citrix Workspace App and VDA) can be affected by server load and server processing time.

To address these and other challenges, the present disclosure provides embodiments of methods and systems for delivering insights of a virtual session to a network device in a real-time, scalable, and/or extensible manner (e.g., without deep parsing by a network device). In some embodiments, a separate or independent VC (sometimes referred to as an App Flow VC) can be established across or between a client-side agent (e.g., desktop virtualization client), network device(s), and a server-side agent (e.g., VDA) for the transmission of insights (e.g., virtualization session insights). The App Flow VC can be negotiated between these entities (e.g., between the desktop virtualization client, network appliances, and VDA). The App Flow VC can facilitate scalable and extensible processing of insights.

Some embodiments of the present methods and systems provide or support state transition of App Flow insights or metrics during network device failover (e.g., high-availability failover). Certain embodiments of the present methods and systems provide or support efficient identification and prioritization of MSI HDX streams. Some embodiments of the present methods and systems provide or support layer 7 (e.g., L7, application layer) latency calculation and communication independent of host processing time. Some embodiments of the present methods and systems provide or support L7 latency calculation and communication between multiple network devices.

Referring again to FIG. 5, the system 500 can incorporate an App Flow VC (e.g., virtual channel 514 or 522) for providing insights, according to an illustrative embodiment. The App Flow VC can incorporate one or more features of the VCs discussed above. In some aspects, the App Flow VC can be identical or similar to other VCs except that the App Flow VC is configured to carry a different type of data stream than that carried by the other VCs. The network link 518, which can include the client 102, server 106, and the ICA stacks, can communicate a data stream of the App Flow VC. The data stream can carry insights (e.g., in packets, frames or other messages) that can be accessed by device(s) in the network link 518.

The systems and methods of the present disclosure may be implemented using or involving any type and form of device, including clients, servers, and/or appliances 200 described above with reference to FIGS. 1A-1B, 2, and 4. As referenced herein, a “server” may sometimes refer to any device in a client-server relationship, e.g., an appliance 200 in a handshake with a client device 102. The server 106 may be an instance, implementation, or include aspects similar to server 106a-n described above with reference to at least FIG. 1A. Similarly, the client 102 may be an instance, implementation, or include aspects similar to any of the clients 102a-n described above with reference to FIG. 1A. The present systems and methods may be implemented using or involving an intermediary device or gateway, such as any embodiments or aspects of the appliance or devices 200 described herein. The systems and methods may be implemented in any type and form of environment, including multi-core devices, virtualized environments, and/or clustered environments as described herein.

The server 106 may host one or more applications or services. Each of the applications or services can include or correspond to any type or form of application or service. The application or service may include a network application, a web application, a Software-as-a-Service (SaaS) application, a remote-hosted application, and so on. As some non-limiting examples, an application can include a word processing, spreadsheet or other application from a suite of applications (e.g., Microsoft Office360, or Google docs), an application hosted and executing on a server for remote provisioning to a client, a desktop application, and/or a HTML5-based application. Packets corresponding to an application or service 510 may be compressed, encrypted, and/or otherwise processed by the VDA and/or ICA stack (sometimes referred to as HDX stack, or VDA HDX stack) of the server 106, and transmitted or delivered to the client 102. The VDA may include the ICA stack 520a—n (e.g., WD 520a, PD 520b, and TD 520c), and can terminate one end of a VC at the server-side agent 504, with the client-side agent 502 terminating the other end of the VC.

In some embodiments, the client 102 may reside at a branch office or an organization for instance, and may operate within a client-side network, which may include or correspond to a private network (e.g., a local area network (LAN) or wide area network (WAN)). In some embodiments, the server 106 and the client 102 may be communicably coupled to one another via a private network (e.g., a LAN or a software-defined wide area network (SD-WAN)). The server 106 may reside at a server or data center, and may operate within a server-side network, which may also be a private network (e.g., a LAN, WAN, etc.).

One or more network devices can be intermediary between the client 102 and the server 106. A network device 508 can include or correspond to any type or form of intermediary device, network device or appliance, gateway device, middle box device, and/or proxy device, such as but not limited to a NetScaler device, SD-WAN device, and so on. Each of the server 106, client 102, and network device(s) in the network link 518 may be communicably coupled in series.

The server-side agent 504 (e.g., VDA) executing on the server 106 may initiate establishment of an App Flow VC. The server-side agent 504 may initiate establishment of an App Flow VC with a client-side agent 502 (e.g., a desktop virtualization client) and/or network device(s) in the path between the server 106 and the client 102. All or some of the server-side agent 504, the client-side agent 502 (e.g., Citrix Workspace App (CWA) or Citrix Receiver), and the network device(s) (e.g., Citrix Gateway, Citrix Gateway Service, Citrix SD-WAN) along the network link can choose to participate in the negotiation of the App Flow VC. These device(s) can advertise their presence and/or capabilities to support the App Flow VC.

For example, the server-side agent's HDX stack can initiate, establish or otherwise enable the App Flow VC, and can send its host-to-client (e.g., server 106 to client 102) insights data on a HDX connection (e.g., using ICA or Common Gateway Protocol (CGP)). The HDX connection may be the same as a HDX connection for carrying one or more other VCs (or HDX VCs), except that the App Flow VC that it carries may be uncompressed and/or non-interleaved with any other HDX VC(s). This is to facilitate efficient parsing of the App Flow VC by network device(s) in the network connection. Any of network device(s) and the client-side agent 502 (e.g., Receiver) may parse and interpret, or simply ignore the insights data in the App Flow VC. Within the App Flow VC, insights data may be sent in a self-descriptive, light-weight extensible format, e.g. in JavaScript Object Notation (JSON) format.

Similarly, the client-side agent's HDX stack may establish or enable the App Flow VC, and send its client-to-host (e.g., client 102 to server 106) insights data via the App Flow VC. The App Flow VC may remain uncompressed and/or non-interleaved with other HDX VCs to facilitate efficient parsing by network device(s). The server-side agent 504 (e.g., VDA) may parse and interpret, or simply ignore the client-to-host insights data in the App Flow VC.

In some embodiments, an App Flow protocol capability or data structure is used to negotiate a configuration (e.g., capabilities) for the App Flow VC, which can include advertising support for the App Flow VC by different entities (e.g., along the network link) to certain entities (e.g., client 102, server 106). The entities can advertise their support for the App Flow VC by performing capabilities exchange between the entities. The entities that are involved in the negotiation can include at least one of the following: (a) server 106 (host), (b) network device A (e.g., gateway), (c) server-side network device B (e.g., SD-WAN device), (d) client-side network device C (e.g., SD-WAN device), or client 102. The capabilities exchange between the entities can determine a behavior of App Flow VC for a particular HDX session. More than one network device (e.g., gateway device, SD-WAN device) may participate in the negotiation. The capabilities exchange can include an entity reporting or advertising an App Flow capability of the entity to one or more entities, or exchanging its App Flow capability with that of one or more other entities.

In some embodiments, the App Flow VC capability may include at least one of the following information or data fields:
Host (or server) Protocol Version
Host (or server) Flags
Gateway Protocol Version
Gateway Flags
Host (or server) side SD-WAN Protocol Version
Host (or server) side SD-WAN Flags
Client-side SD-WAN Protocol Version
Client-side SD-WAN Flags
Client Protocol Version
Client Flags
Session Protocol Version
Session Protocol Flags

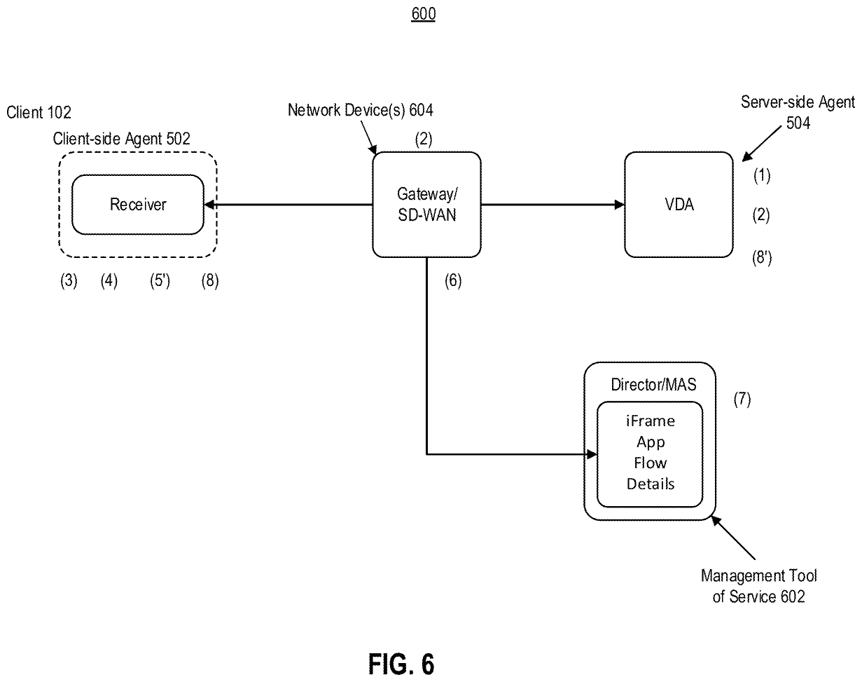

Referring to FIG. 6, a method 600 of negotiating for and using an App Flow VC is depicted, in accordance with an illustrative example. Also depicted in FIG. 6 is a client-side agent 502, a server-side agent 504, network device(s) 604, and a management tool or service 602, that interoperate in connection with the method. As illustrated, various embodiments of the method can include all or some of a number of operations 1 through 8′.

Referring to operation 1, the server-side agent 504 (e.g., VDA) may report a new App Flow capability in a message (e.g., init-request message or packet). If the server 106 does not support the App Flow VC feature or if the App Flow VC feature is disabled in the server 106, the App Flow capability of the server-side agent 504 is not sent to the other entities. Otherwise, the server 106 sends the App Flow capability with the server's protocol version set to the highest version that the server can support. The server may also set additional flags (e.g., including one or more flags listed above) identifying granular App Flow features. In some embodiments, all or some other data fields (e.g., described above) are initially set to zero (e.g., set to 0 by default, or blanked out). The App flow capability may be sent in the message (e.g., an ICA init-request packet) from the server 106 to the client 102.

Referring to operation 2, a network device 604 can set its network device (e.g., gateway or SD-WAN) protocol version in the App Flow capability in the message (e.g., init-request message or packet). Each network device 604 in the server-to-client path (e.g., in the network link) may receive or intercept the message (e.g., init-request packet). The corresponding network device may parse the App Flow capability in turn along the server-to-client path, and set the corresponding network device's respective App Flow protocol version to the highest version it can support. Each network device 604 may also set additional flags (e.g., including one or more flags listed above) identifying granular App Flow features. A protocol version of 0 (e.g., the initial/default value of 0 remains unchanged or is not set by a corresponding network device) may indicate that the corresponding network device is not present in between the server 106 and the client 102 in the network link. If the corresponding network device residing between the server 106 and the client 102 does not support the App Flow protocol or if the App Flow feature is disabled at the corresponding network device, the capability is left unchanged (e.g., the protocol version remains zero). All other data fields in the App Flow capability are left unmodified.

Referring to operation 3, the client-side agent 502 (e.g., Workspace App) may report the capability for the WinStation Driver at the client-side ICA/HDX stack, in the message (e.g., init-response message or packet). If the client 102 does not support the App Flow feature or the feature is disabled at the client 102, the capability is not sent back to the host (e.g., the init-response packet is not transmitted back to the server 106). The capability is also not sent back to the server 106 if there is no network device present between the client 102 and the server 106, and/or there is no server-side agent 504 support for the App Flow VC feature, as indicated by the respective protocol version data fields being zero (e.g., protocol versions of all possible network devices are blanked out or set to zero, and/or protocol version of server 106 is blanked out or set to zero), or lack of App Flow capability being reported by the server 106. Otherwise, the client 102 can send back the App Flow capability to the host, mirroring or maintaining all server and network device data fields that have already been set. The client 102 can set the client's protocol version to the highest version it can support. The client 102 may also set additional flags (e.g., including one or more flags listed above) identifying granular App Flow features. The App Flow capability may be sent in an ICA init-response packet that is transmitted from the client 102 to the server 106.

Referring to operation 4, the client 102 may provide VC-bind information in the message (e.g., in the init-response for the WinStation Driver). The VC-bind information may include App Flow VC in WinStation Driver VC-bind structures. The VC-bind information may include information associating an identifier of a protocol (e.g., protocol name of a VC protocol or ICA protocol) for communicating data using the insights VC, with an identifier of the insights VC or a component (e.g., WinStation Driver or VC module) of the client 102 or server 106. The VC-bind information may include, indicate or identify a protocol name to ID number binding (sometimes referred to as a protocol name to ID number association). The protocol name may refer to or identify the core ICA protocol or a protocol of the App Flow VC. The ID number may identify or refer to at least one of: an associated VC module, the App Flow VC, or the WinStation Driver. The client 102 (e.g., client-side agent 502, or WinStation Driver) may provide or assign the protocol name to ID number binding to an App Flow module that is responsible for implementing the App Flow VC at the client 102. The VC module can be part of the WinStation Driver, or include the WinStation Driver, or may be separate from the WinStation Driver. The VC module can be part of the client-side agent 502 (e.g., VDA), or include the client-side agent 502, or may be separate from the client-side agent 502. The client may load the VC module to implement, initiate, and/or establish the App Flow VC at the client 102. The client may send or report the VC-bind information to the server 106 in the same message (e.g., init-response packet or message) or another message (e.g., another init-response packet or message). The VC-bind information may be sent on behalf of the WinStation Driver responsible for implementing the core ICA protocol that supports the App Flow VC and/or any other VCs. The server 106 can receive the VC-bind information (e.g., VC protocol name to ID number binding), and can use the VC-bind information to access or otherwise open the App Flow VC and send data on it. The VC-bind information can be used by any of the network device(s) 604 in the network link 518 to find and parse out the App Flow VC among other VCs and core protocol.

Referring to operation 5, the server 106 may commit capabilities for the App Flow VC and/or the ICA/HDX session. The server 106 may receive a message (e.g., init-response packet or message) from the client 102, which can include at least one of: the App Flow capability or the VC-bind information. The server can parse, extract, determine and/or analyze the App Flow capability received from the client 102. For example, the server can detect, identify or determine the protocol versions and/or additional flags that might have been set by the client and network device(s) in the App Flow capability.

The server 106 can compute or determine a Session protocol version and/or Session protocol flag(s), for instance using or according to information set in the App Flow capability. For example, the Session protocol version may be set to either 0 or the minimum value of the protocol versions reported by all of the entities (e.g., server, network device(s), and client). The Session protocol version can be set to 0 if no network device 604 between the client 102 and the server 106 supports it (e.g., supports the App Flow VC or feature), or if the client 102 does not support it (e.g., supports the App Flow VC or feature), or if the App Flow VC itself is not reported by the client 102 in a protocol name to ID number binding, and/or if there is neither protocol-level encryption or custom App Flow VC-level encryption negotiated for the session. If the value of the Session protocol version is 0, then no App Flow VC is created or established for the session (e.g., ICA, RDP or HDX session).

The server 106 can commit or finalize the Session protocol version (e.g., if this value is not 0) and/or the Session protocol flag(s) that are computed or determined. The server 106 can communicate or propagate the committed Session protocol version and/or the Session protocol flag(s) to all other entities (e.g., network device(s), client) by including these in an App Flow capability in a message (e.g., an init-connect packet or message) sent from the server to the client. All or some of these entities can read the committed Session protocol version and/or Session protocol flag(s). This process can avoid creating the App Flow VC and/or sending App Flow data points (e.g., insights) unnecessarily if no network devices in the network link (between the client 102 and the server 106) is present, interested in or capable of processing the App Flow insights, and/or if the client-side agent 502 does not support the App Flow feature, and/or if encryption (e.g., protocol-level encryption, or custom App Flow VC encryption) is not negotiated or present. For instance, and in some embodiments, the capability exchange process described herein may also be used to negotiate custom App Flow VC protocol-level encryption methods and keys, so that data sent over the App Flow VC can only be decrypted by a designated network device or the client (e.g., that has access to the custom App Flow VC protocol-level encryption methods and keys).

The server 106 can initiate, establish, create, and/or open the App Flow VC, and can start inserting, writing, providing, and/or sending various insights (e.g., events and data points) into the App Flow VC. The server 106 can initiate, establish, create, and/or open the App Flow VC, and/or provide the insights, responsive to at least one of: determining that the Session protocol version is not 0, committing the Session protocol version and/or the Session protocol flag(s), or sending the committed Session protocol version and/or the Session protocol flag(s) to the other entities. The server 106 can open or create the App Flow VC in the session (e.g., HDX or ICA session), and can leave the protocol packets of App Flow VC (and/or other VCs) uncompressed (e.g., in the top level ICA/HDX protocol), and can leave the protocol packets of App Flow VC (and/or other VCs) non-interleaved (e.g., to facilitate parsing by other entities). The App Flow VC data stream can be compressed (e.g., at the App Flow protocol level). The server 106 can provide session data (e.g., in JSON format or protocol) from various stack or VC components, into corresponding VCs, which may be implemented in user or kernel-mode. The session data can include insights that are directed into the App Flow VC. The App Flow VC can carry messages formed and sent in JSON format, to facilitate parsing by interested entities (e.g., network devices) and/or the client, and to ensure easy extensibility. For instance, the network devices (e.g., gateway and/or SD-WAN devices) may be configured to support and understand the JSON format. However, any other format can be used, that for instance is supported by the entities and/or can be efficiently transmitted and processed.

The App Flow VC can communicate, transmit, carry or convey one or more App Flow messages (e.g., in JSON or other format). Each App Flow messages may include at least one of:
Transport stack connection ID;
HDX Session Globally Unique Identifier (GUID) (facilitates correlation of each individual data point with a user and session environment);
Terminal Services Session ID;
context (additional context to allow other entities to correlate data points);
timestamp; and
source (e.g. Virtual Channel or other system component originating the data point).

In some embodiments, a message may include or contain at least one of: (a) Key (Name), (b) Type, or (c) Value. Messages may be categorized in at least three different groups/types:
i) Version: Such a message can be a first message (e.g., JSON message) sent over the App Flow VC from server to client. Such a message can denote the JSON protocol version, which may be different from the App Flow VC protocol version. Such a message can be used to advertise the set of events and data points implemented by the server to other entities. Similarly, such a message may be a first message (e.g., JSON message) sent over the App Flow VC from client to server, and can be used for a similar purpose.
ii) Event: Such a message can allow the server to signal the occurrence of an event on the server. For example, the server may send an event that signals that “something happened” for a particular VC in a HDX session, or indicate another system event. Similarly, such a message can be used by the client to raise events with other entities.
iii) Key Value: Such a message can describe an individual single data point. For example, such a message can describe that a certain data point has this specific value for a virtual channel in an HDX session.

By way of illustration, events can include but is not limited to one or more of the following:
Application launch, timestamp
Application termination, timestamp
Process termination, timestamp
Session disconnection/termination, timestamp
USB announce device
USB device accepted
USB device rejected
USB device gone
USB device reset
USB device reset endpoint

By way of illustration, data points can include but is not limited to one or more of the following:
Domain name
Logon ticket
Server name
Server version
Session type (e.g., desktop, application)
Client name
Client version
Client serial number
Application name
Application module path
Application process ID
Application launch time
Application termination time
Session termination time
Launch mechanism
Automatic reconnection/Session reliability mechanism
ICA Round Trip Time (RTT)
Layer 7 (L7) latency
VC bandwidth
Multi-stream ICA (MSI) stream type (primary or secondary)

Referring to operation 5′, the client 102 can read the session capabilities, can open the App Flow VC, and can write data into the App Flow VC. The client 102 may read the Session protocol version and/or Session protocol flag(s) committed by the server 106. According to the instructions (e.g., the committed Session protocol version and Session protocol flag(s)), the client 102 may access or open the App Flow VC. Similar to the server 106, the client 102 may send data points via the App Flow VC in the client-to-server direction, to be retrieved by one or more network devices and/or the server 106.

Referring to operation 6, a network device (e.g., gateway or SD-WAN device) 604 may read or access the data (e.g., insights) from the App Flow VC (e.g., data packet or data stream in the App Flow VC). Each interested or capable network device 604 may read the Session protocol version and/or Session protocol flag(s) committed by the server 106. As instructed by the server 106 (e.g., via the committed Session protocol version and/or Session protocol flag(s)), a respective network device 604 may efficiently parse out (e.g., relative to deep parsing) the App Flow VC among other VCs and core protocol (e.g., using the VC-bind information), and may read the insights (e.g., data points) carried in the App Flow VC. The VC-bind information (e.g., VC protocol name to ID number association) may be useful to the network device 604 to detect, identify, and/or parse out the App Flow VC among other VC protocols (e.g., VC-specific or VC-level protocols) and core (or top level ICA/HDX) protocol. The network device 604 may ignore all other protocol(s). This can be further facilitated by the fact that the App Flow VC packets are uncompressed (e.g., at the top level protocol) and non-interleaved. This can substantially improve the number of HDX sessions that may be supported by a network device 604 such as a gateway or SD-WAN device. This also improves the user experience on HDX sessions, since a network device 604 is no longer a bottleneck for processing (e.g., deep parsing) and throughput. The network device 604 may decrypt data points (e.g., at the App Flow VC protocol level) if encryption had been negotiated. (See, e.g., test results discussed below.)

Referring to operation 7, the network device 604 can combine the received App Flow VC data with additional network analytics. The network device 604 can combine the received App Flow VC data with additional network analytics generated, accessed, and/or provided by the network device 604 to form or produce combined insights. The network device 604 can send the combined insights to a management tool of service 602 (e.g., analytics service) for further analysis and/or presentation to an administrator. For example, combined insights may be sent to Citrix Director or Citrix Management and Analytics System (MAS) or a third-party Insights tools. Citrix MAS can correspond to or include a centralized network management and analytics system. From a single platform, administrators can view, manage network devices, and troubleshoot network related issues, or issues with specific published desktops and applications. In some embodiments, the management tool or service (e.g., MAS) 602 may be configured as an App Flow collector on a network device (e.g., Citrix Gateway or Citrix SD-WAN) 604, through which HDX/ICA traffic is flowing. The management tool or service (e.g., MAS) 602 may receive the records (e.g., combined insights) from the network device (e.g., Citrix Gateway or Citrix SD-WAN) 604, analyze the records, and can present them (e.g., in HDX Insight administrator view). The presented data (e.g., in HDX Insights administrator view) may help administrators in troubleshooting issues related to latencies, bandwidth, desktop or application launch time, desktop or application response time, etc.

Referring to operation 8, the client-side agent 502 can read and can drop (e.g., ignore, remove, discard, filter away) the App Flow VC data. The client 102 may read some or all data points, and can drop some or all data points that the client 102 is not interested in. The client 102 may parse, extract, read, and/or interpret the data points (e.g., provided by the server) from the App Flow VC. For example, the client 102 may log information about the App Flow VC data, present information to the end user, respond back to the server, etc. The client may decrypt data points if encryption had been negotiated.

Referring to operation 8′, the server-side agent 504 can read and can drop (e.g., ignore, remove, discard, filter away) App Flow VC data. Similar to the client 102, the server 106 may read and/or ignore some or all of the data points sent by the client 102. For instance, the server 106 may parse, extract, read, and/or interpret the data points (e.g., provided by the client 102) from the App Flow VC. For example, the server 106 may log, present information to the end user, respond back to the client 102, etc. The server 106 may decrypt data points if encryption had been negotiated.

In some embodiments, the client-side agent 502 (e.g., Workspace App) may send some data points on the App Flow VC, which can be correlated with server-side agent 504 (e.g., VDA) data points to provide more insights into an HDX Session. In certain embodiments, the server-side agent 504 (e.g. VDA) may implement, add or insert data points with session or app-specific details, e.g. URL's that may be accessed in the session, etc.

In some embodiments, one or more alternative methods of implementing the App Flow VC may include: (a) Separating CGP connections from a network device to the server-side agent (e.g. VDA); (b) Channeling data from the server-side agent (e.g. VDA) to the monitoring tool/service (e.g. Director/MAS) over an independent transport layer connection; (c) Based on uniquely identifying Connection ID/Session GUID exchanged over HDX protocol, sending tagged data points from each entity (e.g., client-side agent, network device, server-side agent) directly to a Cloud Service. Then the Cloud Service may correlate the data points from the different sources based on a tag (Connection ID/Session GUID). This architecture is more appropriate to customers/organizations that are more willing to accept the use of a Cloud Service as opposed to on-premises customer/organization owned/controlled network devices and services.

Cloud services can be used in accessing resources including network applications. Cloud services can include an enterprise mobility technical architecture, which can include an access gateway in one illustrative embodiment. The architecture can be used in a bring-your-own-device (BYOD) environment for instance. The architecture can enable a user of a client device (e.g., a mobile or other device) to both access enterprise and personal resources from a client device, and use the client device for personal use. The user may access such enterprise resources or enterprise services via a client application executing on the client device. The user may access such enterprise resources or enterprise services using a client device that is purchased by the user or a client device that is provided by the enterprise to the user. The user may utilize the client device for business use only or for business and personal use. The client device may run an iOS operating system, and an Android operating system, among others. The enterprise may choose to implement policies to manage the client device. The policies may be implemented through a firewall or gateway in such a way that the client device may be identified, secured or security verified, and provided selective or full access to the enterprise resources. The policies may be client device management policies, mobile application management policies, mobile data management policies, or some combination of client device, application, and data management policies. A client device that is managed through the application of client device management policies may be referred to as an enrolled device. The client device management policies can be applied via the client application, for instance.

In some embodiments, the operating system of the client device may be separated into a managed partition and an unmanaged partition. The managed partition may have policies applied to it to secure the applications running on and data stored in the managed partition. The applications running on the managed partition may be secure applications. In other embodiments, all applications may execute in accordance with a set of one or more policy files received separate from the application, and which define one or more security parameters, features, resource restrictions, and/or other access controls that are enforced by the client device management system when that application is executing on the device. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple apps as described herein (virtual partition). Stated differently, by enforcing policies on managed apps, those apps may be restricted to only be able to communicate with other managed apps and trusted enterprise resources, thereby creating a virtual partition that is not accessible by unmanaged apps and devices.

The secure applications may be email applications, web browsing applications, software-as-a-service (SaaS) access applications, Windows Application access applications, and the like. The client application can include a secure application launcher. The secure applications may be secure native applications, secure remote applications executed by the secure application launcher, virtualization applications executed by the secure application launcher, and the like. The secure native applications may be wrapped by a secure application wrapper. The secure application wrapper may include integrated policies that are executed on the client device when the secure native application is executed on the device. The secure application wrapper may include meta-data that points the secure native application running on the client device to the resources hosted at the enterprise that the secure native application may require to complete the task requested upon execution of the secure native application. The secure remote applications executed by a secure application launcher may be executed within the secure application launcher application.

The virtualization applications executed by a secure application launcher may utilize resources on the client device at the enterprise resources, among others. The resources used on the client device by the virtualization applications executed by a secure application launcher may include user interaction resources, and processing resources, among others. The user interaction resources may be used to collect and transmit keyboard input, mouse input, camera input, tactile input, audio input, visual input, and gesture input, among others. The processing resources may be used to present a user interface, and process data received from the enterprise resources, among others. The resources used at the enterprise resources by the virtualization applications executed by a secure application launcher may include user interface generation resources, processing resources, among others. The user interface generation resources may be used to assemble a user interface, modify a user interface, refresh a user interface, and the like.

The processing resources may be used to create information, read information, update information, delete information, and the like. For example, the virtualization application may record user interactions associated with a graphical user interface (GUI) and communicate them to a server application where the server application may use the user interaction data as an input to the application operating on the server. In this arrangement, an enterprise may elect to maintain the application on the server side as well as data, files, etc., associated with the application. While an enterprise may elect to “mobilize” some applications in accordance with the principles herein by securing them for deployment on the client device (e.g., via the client application), this arrangement may also be elected for certain applications. For example, while some applications may be secured for use on the client device, others might not be prepared or appropriate for deployment on the client device so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the client device, so the enterprise may elect to provide access to the application through virtualization techniques.

As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the client device. The enterprise can use a client application, which can include a virtualization application, to allow access to applications that are deemed more properly operated on the server side. In an embodiment, the virtualization application may store some data, files, etc., on the mobile phone in one of the secure storage locations. An enterprise, for example, may elect to allow certain information to be stored on the phone while not permitting other information.

In connection with the virtualization application, as described herein, the client device may have a virtualization application that is designed to present GUIs and then record user interactions with the GUI. The virtualization application may communicate the user interactions to the server side to be used by the server-side application as user interactions with the application. In response, the application on the server-side may transmit back to the client device a new GUI. For example, the new GUI may be a static page, a dynamic page, an animation, or the like, thereby providing access to remotely located resources.

The client device may use cloud services to connect to enterprise resources and enterprise services at an enterprise, to the public Internet, and the like. The client device may connect to enterprise resources and enterprise services through virtual private network connections. The virtual private network connections, also referred to as microVPN or application-specific VPN, may be specific to particular applications (e.g., as illustrated by microVPNs), particular devices, particular secured areas on the client device (e.g., as illustrated by O/S VPN), and the like. For example, each of the wrapped applications in the secured area of the phone may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes. The single-sign-on processes may allow a user to provide a single set of authentication credentials, which are then verified by an authentication service. The authentication service may then grant to the user access to multiple enterprise resources, without requiring the user to provide authentication credentials to each individual enterprise resource.

The virtual private network connections may be established and managed by an access gateway. The access gateway may include performance enhancement features that manage, accelerate, and improve the delivery of enterprise resources to the client device. The access gateway may also re-route traffic from the client device to the public Internet, enabling the client device to access publicly available and unsecured applications that run on the public Internet. The client device may connect to the access gateway via a transport network. The transport network may use one or more transport protocols and may be a wired network, wireless network, cloud network, local area network, metropolitan area network, wide area network, public network, private network, and the like.

The enterprise resources may include email servers, file sharing servers, SaaS/Web applications, Web application servers, Windows application servers, and the like. Email servers may include Exchange servers, Lotus Notes servers, and the like. File sharing servers may include ShareFile servers and the like. SaaS applications may include Salesforce, and the like. Windows application servers may include any application server that is built to provide applications that are intended to run on a local Windows operating system, and the like. The enterprise resources may be premise-based resources, cloud based resources, and the like. The enterprise resources may be accessed by the client device directly or through the access gateway. The enterprise resources may be accessed by the client device via a transport network. The transport network may be a wired network, wireless network, cloud network, local area network, metropolitan area network, wide area network, public network, private network, and the like.

Cloud services can include an access gateway and/or enterprise services. The enterprise services may include authentication services, threat detection services, device manager services, file sharing services, policy manager services, social integration services, and application controller services, among others. Authentication services may include user authentication services, device authentication services, application authentication services, data authentication services, and the like. Authentication services may use certificates. The certificates may be stored on the client device, by the enterprise resources, and the like. The certificates stored on the client device may be stored in an encrypted location on the client device, the certificate may be temporarily stored on the client device for use at the time of authentication, and the like. Threat detection services may include intrusion detection services, unauthorized access attempt detection services, and the like. Unauthorized access attempt detection services may include unauthorized attempts to access devices, applications, data, and the like. Device management services may include configuration, provisioning, security, support, monitoring, reporting, and decommissioning services. File sharing services may include file management services, file storage services, file collaboration services, and the like. Policy manager services may include device policy manager services, application policy manager services, data policy manager services, and the like. Social integration services may include contact integration services, collaboration services, integration with social networks such as Facebook, Twitter, LinkedIn, and the like. Application controller services may include management services, provisioning services, deployment services, assignment services, revocation services, wrapping services, and the like.

The enterprise mobility technical architecture of cloud services may include an application store. The application store may include unwrapped applications, pre-wrapped applications, and the like. Applications may be populated in the application store from the application controller. The application store may be accessed by the client device through the access gateway, through the public Internet, or the like. The application store may be provided with an intuitive and easy to use User Interface.

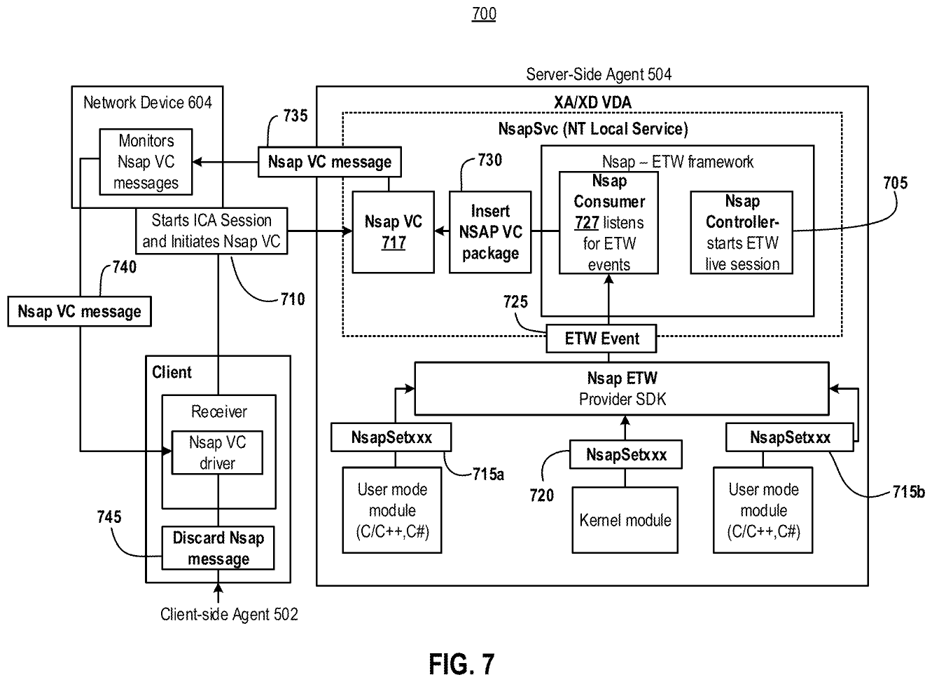

Referring to FIG. 7, an example system that illustrates an implementation of App Flow 700 data points collection and transmission at a server (or server-side agent or VDA) is depicted. The system can include a client-side agent 502 (e.g., Citrix Workspace App or Receiver), a server-side agent 504 (e.g., Citrix Virtual Apps and Desktops VDA), and a network device 604 (e.g., a NetScaler device). In connection with FIG. 7 for instance, NetScaler App Flow (NSAP) is sometimes also referred to as App Flow. Citrix NetScaler (or NetScaler) is referenced here by way of example, and can also be replaced with any type or form of network device. VDA is referenced here by way of example, and can also be replaced with any type or form of server-side agent 504. Likewise, Citrix Workspace App (or Receiver) is referenced here by way of example, and can also be replaced with any type or form of client-side agent 502. The following is an example process flow, and can include some or all of the following operations.

At operation 705, after the VDA boots, the NSAP service on the VDA can instantiate an Event Tracing for Windows (ETW) Controller and can start an ETW live session. At operation 710, the Citrix Workspace App can start an ICA session and a new NSAP driver can initiate the NSAP VC from the Receiver endpoint. The NSAP driver may discard all data coming on this NSAP VC, or it can use the statistics received. At operation 715a and 715b, user mode HDX components on the VDA can use the NSAP SDK (NsapSetxxx) to send data points to Citrix Netscaler App Experience Service (CtxNsapSvc) 717. At operation 720, Kernel mode HDX components on the VDA can use the NSAP SDK (NsapSetxxx) to send data points to CtxNsapSvc. At operation 725, a CtxNsap provider library can send ETW events to the NSAP ETW Consumer 727 hosted by CtxNsapSvc. At operation 730, the NSAP Service can encapsulate the data points (e.g., into a JSON format) and can send it to the NSAP virtual channel (or App Flow VC). At operation 735, network device 604 (e.g., NetScaler) can intercept the NSAP VC message and can extract the required data. At operation 740, the message can further be transmitted to the Citrix Workspace App along with all other HDX traffic. At operation 745, the Receiver NSAP VC driver may discard the NSAP VC message. In testing mode, the NSAP VC driver may parse the content and can display it in DebugView or in a file for test automation purposes. The NSAP VC driver may also interpret the data in non-testing mode.

### F. Systems and Methods for Determining Scales for Buffers for Sessions

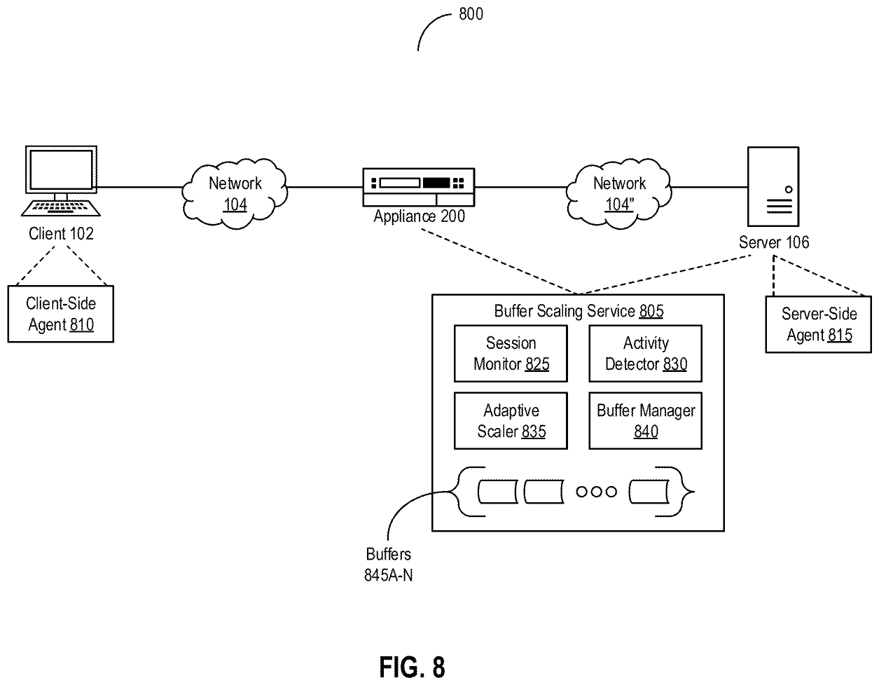

Referring now to FIG. 8, depicted is a system 500 for determining scales for buffers for sessions. In overview, the system 500 may include at least one client 102, at least one server 106, and at least one appliance 200, among others. The client 102 and the appliance 200 may be communicatively coupled with each other via at least one network 104. The appliance 200 and the server may be communicatively coupled with each other via at least one network 104′. The system 800 may also include at least one buffer scaling service 805, which may reside on the appliance 200 or the server 106, or distributed over both. The client 102 may include at least one client-side agent 810, among others. The server 106 may include at least one server-side agent 815, among others. The buffer scaling service 805 may include at least one session monitor 825, at least one activity detector 830, at least one adaptive scaler 835, at least one buffer manager 840, and a set of buffers 845A-N (hereinafter generally referred to as buffers 845), among others. In some embodiments, the system 800 may omit or lack the appliance 200, and the buffer scaling service 805 may reside on the server 106 along with the server-side agent 815. In some embodiments, both the appliance 200 and the server 106 may have separate, independent instances of the buffer scaling service 805.

The systems and methods of the present solution may be implemented in any type and form of device, including clients, servers, and/or appliances 200. As referenced herein, a “server” may sometimes refer to any device in a client-server relationship, e.g., an appliance 200 in a handshake with a client device 102. The present systems and methods may be implemented in any intermediary device or gateway, such as any embodiments of the appliance or devices 200 described herein. Some portion of the present systems and methods may be implemented as part of a packet processing engine and/or virtual server of an appliance, for instance. The systems and methods may be implemented in any type and form of environment, including multi-core appliances, virtualized environments, and/or clustered environments described herein. For example, the client-side agent 810 may be an instance of the client-side agent 502 as detailed above and the server-side agent 815 may be an instance of the server-side agent 504 as detailed above. The appliance 200 may be an instance of the network device 604 or may include the functionalities of the network device 604 as described above. The buffer scaling service 805 may reside in one of the stacks (e.g., the ICA stack) as discussed above.

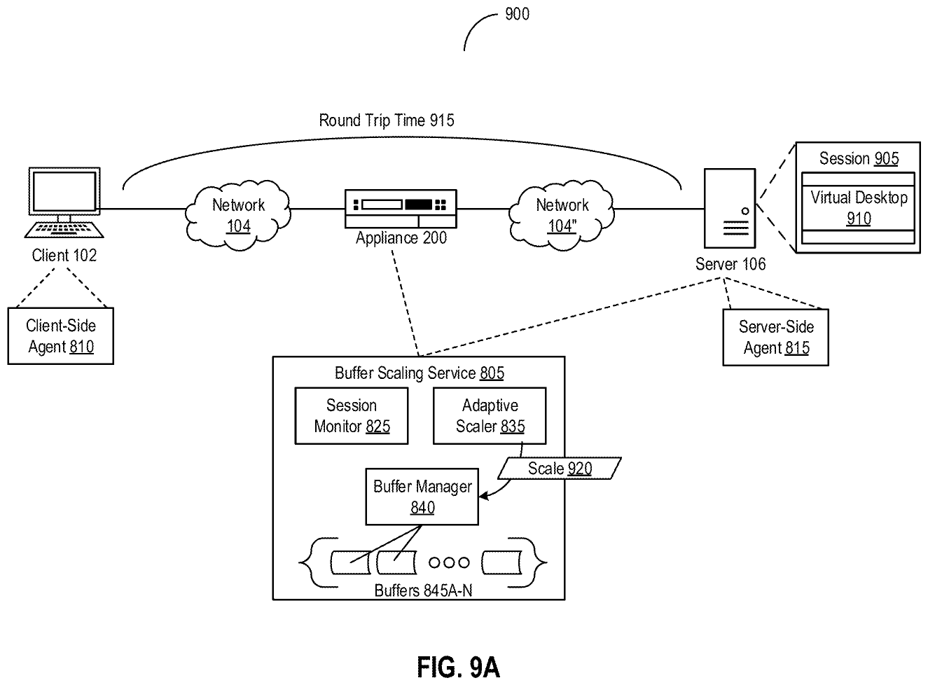

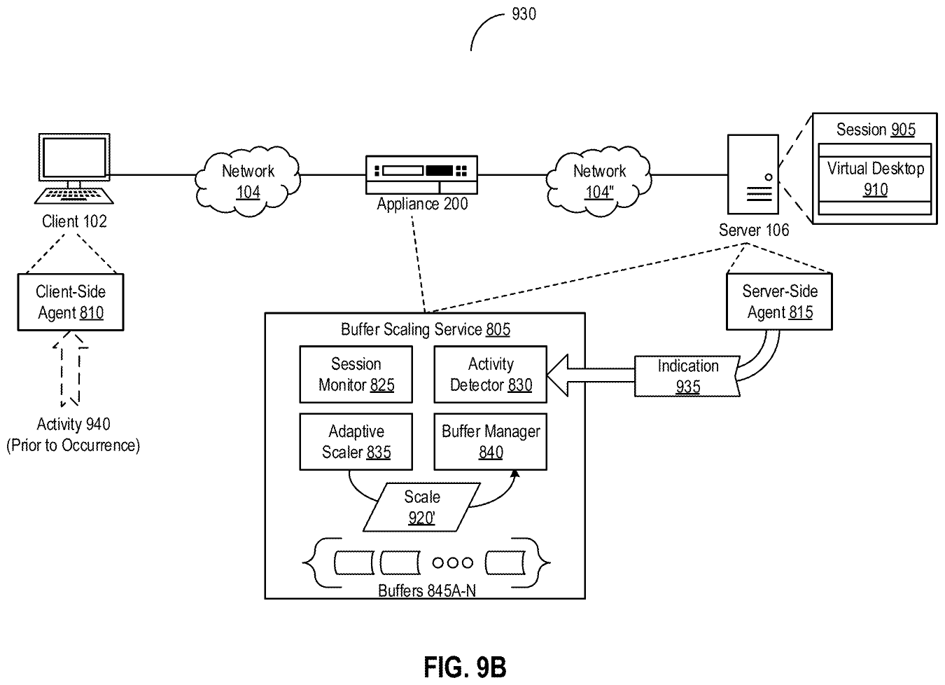

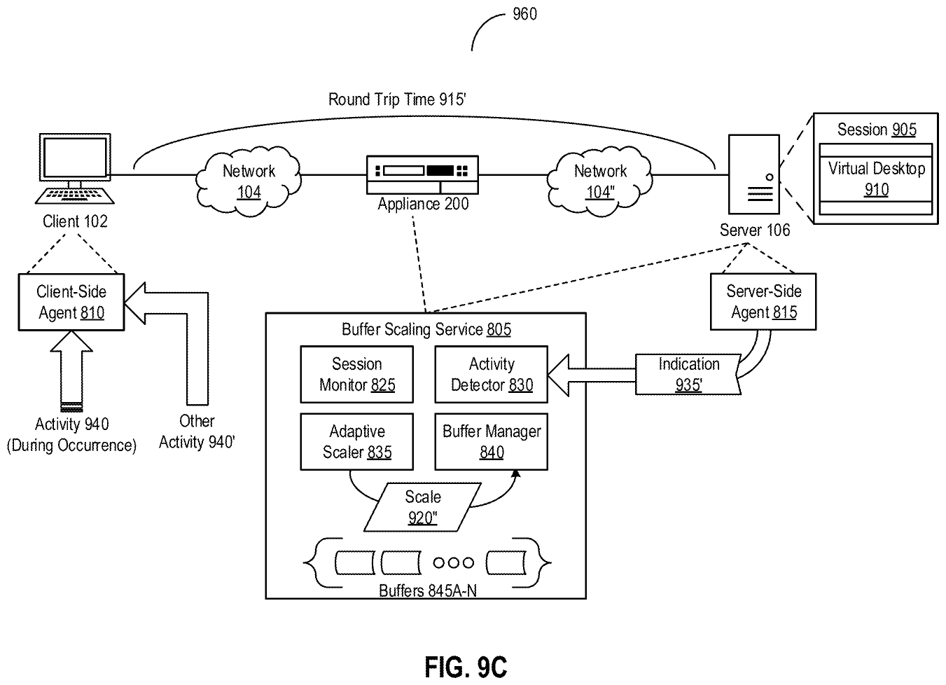

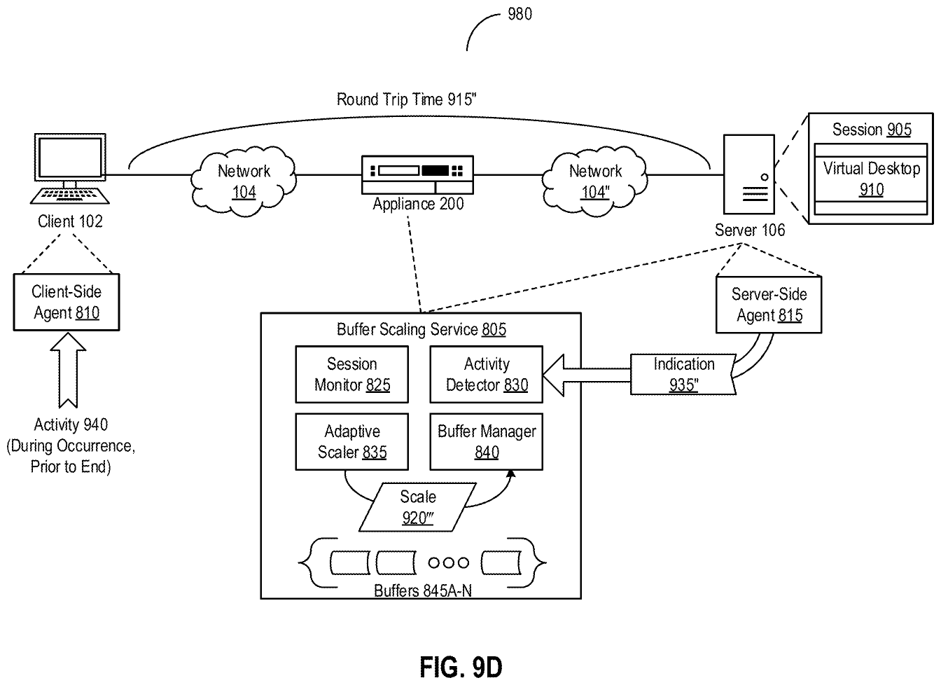

Referring now to FIG. 9A, depicted is a block diagram of a process 900 of initializing buffers of sessions in the system 800 for determining scales. The process 900 may correspond or include operations performed in the system 800 for establishing sessions and initial scaling of buffers for the sessions. Under the process 900, the appliance 200 may initiate or establish at least one session 905 between the client 102 and the server 106. The session 905 may be facilitated by the client-side agent 810 on the client 102 and the server-side agent 815 on the server 106. In some embodiments, the appliance 200 may have a session handler for establishing the session 905 and handling communications for the session 905. In some embodiments, the client 102 and the server 106 may directly initiate and establish the session 905 over the network 104 or 104′, without the appliance 200. The session 905 may be established in response to a request for session from the client-side agent 810 on the client 102. The request may be generated as part of a login process through the client-side agent 810 to be authenticated to access the server 106 or the appliance 200. The session 905 may be established in accordance with a communication protocol, such as the Remote Desktop Protocol (RDP) or the Independent Computing Architecture (ICA), among others.

The session 905 may facilitate, support, or otherwise provide at least one virtual desktop 910 for providing the client 102 (or the client-side agent 810 thereon) access to resources hosted on the server 106. Through the virtual desktop 910 of the session 905, the client 102 may access resources (e.g., one or more applications or other data) hosted on the server 106. The server-side agent 815 on the server 106 may provide the resources as requested by the client-side agent 810 on the client 102 through the session 905. The virtual desktop 910 may be delivered by the server 106 (e.g., as depicted) or the appliance 200 for presentation on the client 102 in accordance with communication protocol (e.g., the RDP or ICA). The virtual desktop 910 may include a graphical user interface (GUI) with one or more user interface elements rendered on at least a portion of the display of the client 102. The user interface elements may be used to access resources hosted on the server 106. For example, the virtual desktop 910 may be rendered in a window for the client-side agent 810 running on the client 102. The virtual desktop 910 may correspond to a desktop interface of an operating system, and may include a set of icons corresponding to applications, directories (e.g., folders), or files accessible via the server 106. The user of the client 102 may access various resources on the server 106 through the session 905 using the virtual desktop 910.

The buffer scaling service 805 may have visibility or access to the session 905 of the client 102. With the visibility, the buffer scaling service 805 may detect function calls, invocations, user interactions, and other processes occurring in the session 905. In addition, the buffer scaling service 805 may check, examine, or otherwise inspect communications over the session 905. The communications may include one or more packets exchanged between the client-side agent 810 and the server-side agent 815 in accordance with the communication protocol. For instance, the buffer scaling service 805 may inspect communications related to the client 102 accessing resources hosted on the server 106 using the virtual desktop 910. The buffer scaling service 805 may also use a hook or an event listener to monitor for events on the client-side agent 810 to provide visibility to the session 905.

The buffer scaling service 805 may execute on the appliance 200 or the server 106 (e.g., as part of the server-side agent 815 or separate from the server-side agent 815). When executed on the appliance 200, the buffer scaling service 805 may retrieve, receive, or intercept the communications of the session 905 exchanged between the client 102 and the server 106. Upon interception, the buffer scaling service 805 may inspect the communications. When executed on the server 106, the buffer scaling service 805 may receive communications destined for the client 102 from the server-side agent 815 on the server 106 prior to transmission. The buffer scaling service 805 may also receive communications from the client 102 destined to other components of the server-side agent 815 prior to conveyance to the components. In some embodiments, the functionality of the buffer scaling service 805 may be distributed across the appliance 200 and the server 106.

For the session 905, the buffer scaling service 805 may supply, make available, or otherwise provide one or more of the set of buffers 845 for the session 905. The set of buffers 845 may be maintained on one or more memory units of the appliance 200 or the server 106, or otherwise accessible to the appliance 200 or the server 106 for the session 905. Each buffer 845 may store data (e.g., packets) to be exchanged between the client 102 and the server 106 for the session 905. Each buffer 845 may also have a set amount of space to store and maintain the data for the session 905. For example, when packets are to be communicated from the server 106 to the client 102, the buffer scaling service 805 may temporarily store the packets on at least one of the buffers 845 prior to transmission to the client 102. Conversely, when packets are to be communicated from the client 102 to the server 106, the buffer scaling service 805 may temporarily store the packets on at least one of the buffers 845 (also referred herein as in-buffers) prior to transmission to the server 106.

The buffer scaling service 805 may configure or assign one or more of the buffers 845 for communications of the session 905. Upon establishment, the buffer scaling service 805 (e.g., using the buffer manager 840) may configure, assign, or otherwise set a default number of buffers 845 for the session 905. The default number of buffers 845 may be configured in accordance with a policy. The policy may, for example, be designated or configured by a network administrator of the server 106 or appliance 200). Through the duration of the session 905, the number of buffers 845 assigned to the session 905 may vary, depending on various conditions as detailed herein below.

The session monitor 825 executing on the buffer scaling service 805 may calculate, determine, or otherwise identify at least one round trip time 915 (also referred herein as an instantaneous round trip time) of the session 905 for the client 102. In some embodiments, the identification of the initial round trip time 915 may be performed by the session monitor 825 in response to establishment of the session 905. The round trip time 915 may identify or otherwise correspond to an amount of time for data (e.g., a packet) to be sent from one end (e.g., the server 106) to the other end (e.g., the client 102) and response data (e.g., a packet) to be received from the recipient end (e.g., the client 102) to the sender end (e.g., the server 106). The round trip time 915 may also represent or correspond to interactivity of the data communicated in the session 905.

To measure the round trip time 915, the session monitor 825 may identify a time at which a packet is sent by the server 106 to the client 102 and a time at which a response is received by the server 106 from the client 102 during the session. Conversely, the session monitor 825 may identify a time at which a packet is sent by the client 102 to the server 106 and a time at which a response is received by the client 102 from the server 106. In either case, the session monitor 825 may calculate a difference in the time at which the packet is sent and the time at which response is received to use as the round trip time 915. The packet exchanged between the client 102 and the server 106 may include a tag identifying that the packet is used for calculation of the round trip time 915.

During the session 905, the session monitor 825 may calculate, determine, or otherwise identify one or more round trip times 915 of the session 905. The identification of the updated or subsequent round trip times 915 may be similar to the identification of the round trip time 915 as described above. In some embodiments, the session monitor 825 may identify the round trip time 915 at an interval (e.g., at a sampling rate). With the identifications of multiple round trip times 915, the session monitor 825 may calculate or determine an aggregate round trip time 915. The determination of the aggregate round trip time 915 may be based on a function of the acquired round trip times 915, such as a moving average, weighted moving average, an exponential moving average, or smoothing function, or any combination thereof among others.

In some embodiments, the session monitor 825 may determine the aggregate round trip time 915, upon acquisition of a set number of round trip times 915 (e.g., 5 to 15 round trip time measurements). In some embodiments, the session monitor 825 may eliminate, exclude, or otherwise remove round trip times 915 with outlier values from the determination of the aggregate round trip time 915. For instance, if the measured round trip time 915 has a value above a threshold relative to the previous aggregate round trip time 915 (e.g., 5 times more), the session monitor 825 may remove the measured round trip time 915 from the determination of the subsequent aggregate round trip time 915. The session monitor 825 may use the remaining set of measured round trip times 915 to calculate the aggregate round trip time 915. The aggregate round trip time 915 may be used to configure or set the number of buffers 845 to provide for the session 905.

The adaptive scaler 835 executing on the buffer scaling service 805 may calculate or determine at least one scale 920 with which to configure or set the number of buffers 845 to provide for the session 905. The determination of the scale 920 may be based on the measurements of round trip time 915, such as the instantaneous round trip time 915 or the aggregate round trip time 915. The scale 920 may specify or identify whether to increase, decrease, or maintain the number of buffers 845 to provide for the session 905. For instance, the scale 920 may be a numerical value, such as a multiplicative factor or percentage, to adjust or change the number of buffers 845. In some embodiments, the scale 920 may also specify, define, or otherwise identify the number of buffers 845 to provide for the session 905.

To determine the scale 920, the adaptive scaler 835 may calculate, generate, or otherwise determine a deviation of the round trip time 915 from at least one reference value. The reference value may identify an expected value for the round trip time 915. The reference value may be pre-determined or set based on network metrics from other sessions. For instance, the reference value may be determined using round trip time measurements of sessions established over the appliance 200 or with the server 106. The deviation may identify or correspond to a difference between the round trip time 915 and the reference value. In some embodiments, the deviation may correspond to or identify an amount or percentage of difference between the round trip time 915 and the threshold.

With the determination, the adaptive scaler 835 may compare a deviation of round trip time 915 from the reference value to at least one threshold. The threshold may delineate, define, or otherwise identify a value for the round trip time 915 at which to increase, decrease, or maintain the number of buffers 845 to provide for the session 905. The threshold may also be used to determine the number of buffers 845 to provide based on the round trip time 915. In some embodiments, the adaptive scaler 835 may compare the deviation of the round trip time 915 with a set of thresholds. Each threshold may identify a value for the round trip time 915 at which to increase or decrease the number of buffers 845 by a corresponding scale 920. In general, the greater the deviation, the greater the number of buffers 845 may be determined for the scale 920. For instance, if the round trip time 915 is greater than 50-75% of the threshold, the adaptive scaler 835 may determine that 15% more buffers 845 are to be provided. If the round trip time 915 is greater than 75% of the threshold, the adaptive scaler 835 may determine that 35% more buffers 845 are to be provided.

If the deviation of the round trip time 915 is less than the threshold, the adaptive scaler 835 may also determine the scale 920 to maintain or decrease the number of buffers 845 to provide for the session 905. The scale 920 may, for example, be a multiplicative factor less than or equal to 1 to decrease or maintain the number of buffers 845. The number of buffers 845 may be maintained or decreased to optimize resources from better network conditions (e.g., low latency or high throughput). In some embodiments, the adaptive scaler 835 may identify the scale 920 corresponding to the threshold of the set of threshold for which the deviation of the round trip time 915 is less than. On the other hand, if the deviation of the round trip time 915 is greater than or equal to the threshold, the adaptive scaler 835 may determine the scale 920 to increase the number of buffers 845 to provide for the session 905. The scale 920 may be, for instance, a multiplicative factor greater than 1 to increase the number of buffers 845 to provide for the session 905. The number of buffers 845 may be increased to factor in poor network conditions (e.g., high latency or low throughput) or to account for different utilizations of the session 905. In some embodiments, the adaptive scaler 835 may identify the scale 920 corresponding to the threshold of the set of threshold, for which the deviation of the round trip time 915 is greater than or equal to.

In some embodiments, the adaptive scaler 835 may identify or determine the scale 920 as a function of the round trip time 915. The function may correspond or map the round trip time 915 (e.g., the instantaneous or aggregate) to a numerical value to adjust or set the number of buffers 845 to provide for the scale 920. In some embodiments, the function may map a difference between the round trip time 915 and the threshold with the numerical value for the scale 920. In some embodiments, the function may map the round trip time 915 relative to the threshold with the number of buffers 845 to use as the scale 920. The function may be set or configured by a network administrator of the appliance 200 or the server 106. Using the function, the adaptive scaler 835 may identify the numerical value for the scale 920.

The buffer manager 840 executing on the buffer scaling service 805 may configure, assign, or otherwise set the number of buffers 845 to provide to the session 905 in accordance with the determined scale 920. Upon determining the scale 920, the buffer manager 840 may find or identify the current set of buffers 845 assigned to the session 905. The presently provided set may have the default number of buffers 845 assigned, when the session 905 is initialized. When the scale 920 is to maintain the number of buffers 845, the buffer manager 840 may keep, retain, or otherwise maintain the number of buffers 845 assigned to the session 905. The current set of buffers 845 may also continue to store data to be exchanged between the client 102 and the server 106 prior to communication over the session 905. When the scale 920 is to decrease the number of buffers 845, the buffer manager 840 may disassociate, take away, or otherwise remove a subset of the buffers 845 from the session 905. The subset of buffers 845 to be removed may be in accordance with the scale 920. For example, if the scale 920 specifies that 10% of buffers 845 are to be removed, the buffer manager 840 may remove a corresponding subset of buffers 845 from being assigned to the session 905. The removed buffers 845 may be freed up or made available for reassignment to other sessions 905 with the server 106 or over the appliance 200.

Continuing on, when the scale 520 is to increase the number of buffers 845, the buffer manager 840 may augment, supplement, or otherwise assign additional buffers 845 for the session 905. The buffers 845 to be added for the session 905 may be in accordance with the scale 920. The buffer manager 840 may find, select, or otherwise identify buffers 845 available for the session 905, such as buffers 845 not assigned to any other sessions 905 with the server 106 or over the appliance 200. With the identification, the buffer manager 840 may identify a subset of buffers 845 to assign to the session 905 based on the scale 920 and the number of buffers 845 currently assigned to the session 905. For instance, there may be 10 buffers 845 currently assigned to the session 905. If the scale 920 specifies that 20% more are to be added, the buffer manager 840 may determine that two additional buffers 845 are to be assigned. From the buffers 845 identified as available, the buffer manager 840 may assign or set two of the available buffers 845 to the session 905. The buffer manager 840 may also remove these buffers 845 from the set of available buffers 845 for other sessions 905. Once assigned, the newly added buffers 845 may store data to be exchanged between the client 102 and the server 106 prior to communications over the session 905.

In some embodiments, the buffer manager 840 may provide, send, or otherwise transmit information on the number of buffers 845 provided for the session 905 to another instance of the buffer manager 840. The information may identify or include the scale 920, the number of buffers 845 provided for the session 905, and an amount of change in the number of buffers 845, among others. For example, the buffer manager 840 of the instance of the buffer scaling service 805 on the server 106 may transmit the information to the instance of the buffer scaling service 805 on the appliance 200. The buffer manager 840 on the appliance 200 in turn may also configure or set the number of buffers 845 on the appliance 200 in accordance with the information provided by the buffer manager 840 on the server 106. The setting of the number of buffers 845 on the appliance 200 may be in a similar manner as the setting of the number of buffers 845 as discussed above. The number of buffers 845 provided by the appliance may difference from the number of buffers 845 provided by the server 106. For example, the adaptive scaler 835 on the appliance 200 may apply a different policy to the indication 935 to determine a scale 920 that is different from the scale 920 determined by the adaptive scaler 835 on the server 106. Using the difference scale 920, the buffer manger 840 on the appliance 200 may set a different number of buffers 845 to provide for the session 905.

With additional measurements of the round trip times 915 and the determinations of scales 920 (e.g., at each sampling interval), the buffer manager 840 may adjust, update, or otherwise reset the number of buffers 845 to provide for the session 905. The subsequent setting of the number of buffers 845 for the session 905 may be similar as discussed above. For example, the session monitor 825 may identify a new round trip time 915 (e.g., instantaneous or aggregated) for the session 905. Using the new round trip time 915, the adaptive scaler 835 may determine a new scale 920 to increase, decrease, or maintain the number of buffers 845 for the session 905. In accordance with the scale 920, the adaptive scaler 835 may set the number of buffers 845 to assign for communications of the session 905. This process may be repeated any number of times throughout the duration of the session 905.

Referring now to FIG. 9B, depicted is a block diagram of a process 930 of scaling buffers in response to indications of initiation of activities in the system 800 for determining scales. The process 930 may correspond to or include operations performed in the system 800 for determining scales detecting indications of events prior to occurrence. Under the process 930, the activity detector 830 executing on the buffer scaling service 805 may check or otherwise monitor for at least one indication 935 in advance of at least one activity 940 on the client 102 to access through the session 905. The activity 940 may include or correspond to a set of interactions between the user and the client 102 (or virtual desktop 910 provided through the client-side agent 810) to access resources (e.g., hosted on the server 106 or elsewhere) through the session 905. For example, the activity 940 may include user interactions on the application provided through the virtual desktop 910, performing data transfer (e.g., uploading or downloading) through the session 905, or playing streaming video through the session 905, among others.

Continuing on, the activity 940 may also include or correspond to a set of function calls invoked in the session 905 (e.g., via an application in the virtual desktop 910) to access various resources through the session 905. The indication 935 (sometimes herein referred to as hints) may identify, include, or otherwise correspond to any interactions, function invocations, or communications, or any combination thereof, correlated with, corresponding to, or otherwise associated with the activity 940. The activity 940 itself may have a start (or initialization), a middle (or in process), and an end (or termination) with respect to occurrence of the activity 940. The indication 935 may be in advance of the start of or the end to the occurrence of the activity 940. The depicted example focuses on the detecting the indication 935 prior to the start of the activity 940.

To monitor for the indication 935, the activity detector 830 may use one or more event listeners within the session 905 (e.g., in the virtual desktop 910 or applications accessed therein). The event listeners may be provided by the server 106 or the appliance 200 facilitating the session 905 or may be added to the applications in the session 905 by the client-side agent 810 on the client 102 or the server-side agent 815 on the server 106. Each event listener may monitor for a defined set of user interactions or function calls associated with the start of a corresponding type of activity 940, prior to the occurrence of the start of the activity 940. For instance, at least one event listener may be configured to pick up on user interactions associated with print requests made from a word processing applications, prior to the occurrence of the printing. Upon invocation, the event listener (e.g., on the server-side agent 815) may convey, provide, or otherwise send the indication 935 to the buffer scaling service 805. The activity detector 830 may identify a single indication 935 in advance of at least one activity 940 or multiple indications 935 in advance of activities 940 from the corresponding event listeners over a set period of time (e.g., the sampling rate for measuring the round trip time). The indication 935 may identify the type of activity 940 based on the user interactions. The indication 935 may also identify that the identification of the activity 940 is prior to the start of the activity 940. With receipt, the activity detector 830 may in turn detect the indication 935 in advance of the start of the activity 940.

In some embodiments, the indication 935 may be provided, transmitted, or otherwise sent from the event listener (e.g., on the server-side agent 815) to one or more instances of the buffer scaling service 805. The transmission of the indication 935 may be transmitted in-band or out-of-band with respect to the communications over the session 905 (e.g., through one or more of the virtual channels for the session 905). For example, the indication 935 may be provided to an instance of the buffer scaling service 805 on the appliance 200. The instance of the buffer scaling service 805 on the appliance 200 may use the indication 935 to determine a scale used to set a number of buffers 845 to provide for the session 905 in a similar manner as detailed herein. The appliance 200 may also record, log, or otherwise store the indication 935 for analytics purposes.

In some embodiments, the activity detector 830 may receive, intercept, or otherwise identify communications (e.g., packets) in the session 905 to monitor for the indication 935 in advance of the start of the activity 940. With the identification, the activity detector 830 may compare the communications with a set of rules. Each rule may specify or define a pattern of communications associated with a corresponding type of activity 940. Certain patterns in the communications within the session 905 may be associated with the start of the activity 940. Each rule may also specify a pattern of communications in advance of the start of the activity 940, during the occurrence of the activity 940, or the end of the activity 940, among others. The example depicted may be focused on the indication 935 in advance of the start of the activity 940. When the communications does not match with any of the rules for start of a corresponding activity 940, the activity detector 830 may refrain from detecting the indication 935, and may continue to monitor.

Conversely, when the communications matches with a rule for a start of a corresponding activity 940, the activity detector 830 may determine or detect the indication 935 in advance of the start of the activity 940 corresponding to the rule. In addition, the activity detector 830 may identify that the identification of the activity 940 is in advance of the start of the occurrence of the activity 940 (e.g., as depicted). For example, a request to download files received from the client 102 may be correlated with a start of an activity 940 to perform a bulk download from the server 106 through the session 905. If the communication includes the request to download files, the activity detector 830 may identify the indication 935 of the activity 940 to download files in advance of the actual performance of the downloading. The activity detector 830 may identify a single indication 935 in advance of at least one activity 940 from comparing the communications with a corresponding rule. The activity detector 830 may also identify multiple indications 935 in advance of activities 940 from the communications within a set period of time by comparing to corresponding rules.

With detection of the indication 935, the activity detector 830 may identify or otherwise determine a type of the activity 940. The type of the activity 940 may be, for example, a user interactive activity, a bulk data transfer, and multimedia communications, among others. Examples of a user interactive activity include user interactivity with an application provided through the session 905, such as combination of keyboard or mouse input to perform actions on the graphical use interface (GUI) of the application, among others. Example of a bulk data transfer may include downloading or uploading files through the session 905 or printing files accessed in the session 905, among others. Examples of multimedia communications may generally include real-time or near real-time traffic, such as video or audio playback, video conferencing, and voice over Internet Protocol (VoIP), among others. The type of the activity 940 may be categorized into interactive (e.g., user interactive activity), non-interactive (e.g., bulk data transfer), or mixture (e.g., multimedia communications), among others.

From the indication 935, the activity detector 830 may determine or identify the type of activity 940. For example, the activity detector 830 may inspect the communications or the function calls from the session 905 leading to the indication 935 to determine the type of activity 940 to be performed. If multiple activities 940 are detected with the one or more indication 935, the activity detector 830 may determine the type of activity 940 for each detected activity 940. When the indication 935 is associated with the user interactive activity (or interactive type), the activity detector 830 may determine that the type of activity 940 is user interactive activity. When the indication 935 is associated with a bulk data transfer (or non-interactive type), the activity detector 830 may determine that the type of activity 940 is bulk data transfer. When the indication 935 is associated with multimedia communications (or mixture), the activity detector 830 may determine that the type of activity 940 is for multimedia communications. In some embodiments, when the buffer scaling service 805 resides on the server 106, the activity detector 830 may provide, transmit, or otherwise send the indication 935 to the appliance 200. The transmission of the indication 935 may be transmitted in-band or out-of-band with respect to the communications over the session 905. The appliance 200 may record, log, or otherwise store the indication 935 for analytics purposes.

With the identification of the indication 935, the session monitor 825 may identify other characteristics regarding the session 905, besides the round trip time 915 for determining a scale to set the buffers 845 for the session 905. The session monitor 825 may measure, determine, or identify network metrics of the session 905 between the client 102 and the server 106. The network metrics may include, for example, bandwidth, network delay, jitter, or throughput, among others, for the session 905. The bandwidth may correspond to an amount of data capable of communication over a period of time between the client 102 and the session 106 over the session 905. The network delay may identify an amount of latency of data communicated between the client 102 and the session 106 in the session 905. The jitter may identify a variation in delay of packets communicated in the session 905. Throughput may identify an amount of data that is communicated in the session 905 over a period of time.

In some embodiments, the session monitor 825 may identify measurements (e.g., the network metrics) from other sessions 905 to be used to determine the scale for the number of buffers 845 to provide. The session monitor 825 may identify the other sessions 905 having the same type of the activity 940 as the session 905. The other sessions 905 may be currently active or previously established. For example, the session monitor 825 may identify other previously established sessions 905 where an indication 935 of multimedia communications was detected for the session 905. With the identification, the session monitor 825 may determine or identify the network metrics using session data of the other sessions 905. The network metrics may also include, for example, bandwidth, network delay, jitter, or throughput as discussed above, among others.

In some embodiments, with the detection of the indication 935 in advance of the activity 940, the session monitor 825 may identify a process on which the activity 940 is to be performed. The process may be a foreground process or a background process. The foreground process may correspond to an application with a topmost window in the virtual desktop 910 provided via the session 905 to the client 102. The background process may correspond to applications besides the application with the topmost window within the virtual desktop 910 provided via the session 905. With the detection of the indication 935, the session monitor 825 may determine or identify whether the process on which the corresponding activity 940 is the foreground process or the background process. When multiple indications 935 are detected, the session monitor 825 may identify the process for each corresponding activity 940. For instance, the session monitor 825 may identify one activity 940 as to be performed on the foreground process and another activity 940 as to be performed in the background process.

In some embodiments, the session monitor 825 may access the data provided for presentation via the session 905 to retrieve, determine, or identify one or more characteristics. The characteristics may include, for example, frame rate, display resolution, compression type, and signal-to-noise ratio (SNR), among others. The session monitor 825 may access the rendering of the virtual desktop 910 provided by the session 905 for presentation via the client 102 (or the client-side agent 810). In some embodiments, the session monitor 825 may identify the content presented in the process on which the activity 940 is to be performed. With the identification, the session monitor 825 may determine the characteristics of the content presented through the process in the virtual desktop 910 of the session 905. For instance, the session monitor 825 may identify the streaming video content to be presented, when the detected indication 935 is for a multimedia communications activity. From the presented content, the session monitor 825 may measure the frame rate, display resolution, and compression type, among others characteristics.

The adaptive scaler 835 may calculate, identify, or otherwise determine at least one scale 920′ based on the type of activity 940. The determination of the scale 920′ may be based on the type of activity 940 as detected with the indication 935 in advance of the start of the occurrence of the activity 940. In some embodiments, the determination of the scale 920′ may be based on any number of factors, such as the type of activity 940, whether the indication 935 is in advance of the start of occurrence of the activity 940 (e.g., corresponding to the focus in the depiction) or the end of the occurrence of the activity 940, the network metrics, the characteristics of data, the process (e.g., foreground or background process) on which the activity 940 is to be performed, among others. In some embodiments, the adaptive scaler 835 may determine the scale 920′ in response to the detection of the indication 935. In some embodiments, the adaptive scaler 835 may determine the scale 920′ at the sampling interval.

In some embodiments, the adaptive scaler 835 may determine the scale 920′ using the indication 935 in accordance with at least one policy. The policy may define, identify, or otherwise specify the scale 920′ at which to provide the number of buffers 845 based on the type of the activity 940 (or the factors listed above). In some embodiments, the policy may specify priorities for the types of activities 940 to be used for determining the scale 920′. For instance, the policy may define that the bulk data transfer indication is to be ignored, when a user interactive activity is detected within the same time frame. In some embodiments, the policy may define priorities for processes on which the corresponding activities 940 are detected. For example, the policy may specify that an activity 940 which is to be performed on the foreground process is to take precedence over another detected activity 940 on a background process for determining the scale 920′. The policy can be set or configured by a system administrator of the appliance 200, the server 106, or the buffer scaling service 805.

If there are multiple activities 940 identified with the detection of one or more indications 935 in advance of the activities 940, the adaptive scaler 835 may identify or select the activity 940 to be used for determining the scale 920′. The selection of the activity 940 to be used may be in accordance with priorities for the activities 940 (e.g., as defined by the policy). In some embodiments, from the identified activities 940, the adaptive scaler 835 may select the activity 940 to be performed in the foreground process in accordance with the policy. The activity 940 associated with the foreground process may be assigned the highest priority by the policy. In some embodiments, the adaptive scaler 835 may identify a corresponding priority for each activity 940 as defined by the policy. For example, the adaptive scaler 835 may identify one priority for an activity 940 to be performed on one process (e.g., a foreground process) and another priority for another activity 940 to be performed on another process (e.g., a background process). Based on the priorities, the adaptive scaler 835 may select the activity 940 to use in determining the scale 920′. For example, the activity 940 with the highest assigned priority may be used to determine the scale 920′. With the selection, the adaptive scaler 835 may use the type of the activity 940 (and related factors) to determine the scale 920′.

When the detected indication 935 is in advance of the start of the user interactive activity, the adaptive scaler 835 may determine the scale 920′ to decrease the number of buffers 845 to provide for the session 905. The scale 920′ may, for example, be a multiplicative factor less than 1 to decrease the number of buffers 845. In some embodiments, the adaptive scaler 835 may identify the scale 920′ as defined by the policy for the indication 935 is in advance of the start of the user interactive activity. The adaptive scaler 835 may determine the scale 920′ to varyingly decrease over a subsequent period of time. For instance, the adaptive scaler 835 may determine the scale 920′ to decrease at a higher rate for a time window after the detection of the indication 935. The adaptive scaler 835 may then determine the scale 920′ to decrease at a lower rate after the window of time until detecting of the end of the occurrence of the activity 940.

When the detected indication 935 is in advance of the start of the bulk data transfer, the adaptive scaler 835 may determine the scale 920′ to increase the number of buffers 845 to provide for the session 905. The scale 920′ may, for example, be a multiplicative factor greater than to 1 to increase the number of buffers 845. In some embodiments, the adaptive scaler 835 may identify the scale 920′ as defined by the policy for the indication 935 is in advance of the start of the bulk data transfer. The adaptive scaler 835 may determine the scale 920′ to varyingly increase over a subsequent period of time. For example, the adaptive scaler 835 may determine the scale 920′ to increase at a higher rate for a time window after the detection of the indication 935. The adaptive scaler 835 may then determine the scale 920′ to increase at a lower rate after the window of time until detecting of the end of the occurrence of the activity 940.

Continuing on, when the detected indication 935 is advance of the start of the multimedia communications, the adaptive scaler 835 may determine the scale 920′ using a number of factors. The factors may include, for example, the network metrics of the session 905, the characteristics of the data (e.g., frame rate of the content to be rendered) communicated via the session 905, and measurements from other sessions 905 (e.g., also with multimedia communications), among others. The scale 920′ may be determined to facilitate for maintaining quality and smoothness of the data to be presented via the session 905 during the multimedia communications. In some embodiments, the adaptive scaler 835 may identify the scale 920′ as defined by the policy for given set of factors when the detected indication 935 is for multimedia communications. For a certain set of factor inputs, the policy may identify the scale 920′ to decrease the number of buffers 845. For another set of factor inputs, the policy may identify the scale 920′ to increase the number of buffers 845.

The buffer manager 840 may configure, assign, or otherwise set the number of buffers 845 to provide to the session 905 in accordance with the determined scale 920′. The setting of the number of buffers 845 to provide based on the scale 920′ may be similar to the setting of the number of buffers 845 using the scale 920 as discussed above. Upon determining the scale 920′, the buffer manager 840 may find or identify the current set of buffers 845 assigned to the session 905. When the scale 920′ is to decrease the number of buffers 845 (e.g., as with user interactive activity), the buffer manager 840 may disassociate, take away, or otherwise remove a subset of the buffers 845 from the session 905. The subset of buffers 845 to be removed may be in accordance with the scale 920′.

When the scale 920′ is to increase the number of buffers 845 (e.g., as with bulk data transfer activity), the buffer manager 840 may augment, supplement, or otherwise assign additional buffers 845 for the session 905. The buffers 845 to be added for the session 905 may be in accordance with the scale 920′. The buffer manager 840 may find, select, or otherwise identify buffers 845 available for the session 905, such as buffers 845 not assigned to any other sessions 905 with the server 106 or over the appliance 200. With the identification, the buffer manager 840 may identify a subset of buffers 845 to assign to the session 905 based on the scale 920′ and the number of buffers 845 currently assigned to the session 905. Once identified, the buffer manager 840 may assign the subset of buffers 845 to the session 905.

In some embodiments, the buffer manager 840 may provide, send, or otherwise transmit information on the number of buffers 845 provided for the session 905 to another instance of the buffer manager 840. The information may identify or include the scale 920′, the number of buffers 845 provided for the session 905, and an amount of change in the number of buffers 845, among others. The buffer manager 840 in turn may also configure or set the number of buffers 845 on the appliance 200 in accordance with the information provided by the buffer manager 840 on the server 106 (e.g., the scale 920′ determined based on the type of the activity 940). The setting of the number of buffers 845 on the appliance 200 may be in a similar manner as the setting of the number of buffers 845 as discussed above.

Referring now to FIG. 9C, depicted is a block diagram of a process 960 of scaling buffers during performance of activities in the system 800 for determining scales. The process 960 may correspond to or include operations performed in the system 800 for determining scales at least partially concurrent with the occurrence of the detected events as discussed in conjunction with the process 930 above. Under the process 960, while the number of buffers 845 are set and provided for the session 905 in accordance with the scale 920′, the session monitor 825 may calculate, determine, or otherwise identify at least one round trip time 915′ (also referred herein as an instantaneous round trip time) of the session 905 for the client 102. The identification of the round trip time 915′ may be similar to the identification of the round trip time 915 as detailed herein above. To measure, the session monitor 825 may calculate a difference in the time at which a packet is sent from one end and the time at which a response from the other end is received to use as the round trip time 915′.

In some embodiments, the session monitor 825 may determine the aggregate round trip time 915′ using a set number of round trip times 915′ (e.g., 5 to 15 round trip time measurements). The determination of the aggregate round trip time 915′ may be similar to the determination of the aggregate round trip time 915 as discussed herein above. The determination of the aggregate round trip time 915′ may be based on a function of the acquired round trip times 915′, such as a moving average, weighted moving average, an exponential moving average, or smoothing function, or any combination thereof among other. The aggregate round trip time 915′ may be used to configure or set the number of buffers 845 to provide for the session 905.

In conjunction, the activity detector 830 may continue to monitor for at least one indication 935′ in advance of another activity 940′ on the client 102 to access through the session 905. The indication 935′ of the other activity 940′ may be detected in advance, while the number of buffers 845 are provided in accordance with the scale 920′ using the previously identified activity 940. The monitoring for and detection of the indication 935′ in advance of another activity 940′ during the process 960 may be similar to the monitoring for and detection of the indication 935 in advance of the activity 940 during the process 930 as detailed herein above. In addition, the indication 935′ may also be sent from the server 106 (e.g., or the server-side agent 815) to the appliance 200, in a similar manner as discussed above with respect to the indication 935. With the detection of the indication 935′, the activity detector 830 may identify or otherwise determine a type of the activity 940′. The determination of the type of the activity 940′ during process 960 may also be similar to the determination of the type of the activity 940 during process 930 as discussed above.

With the determination, the activity detector 830 may compare the type of the activity 940′ with the type of the activity 940. As discussed above, the type of the activity 940′ may be, for example, a user interactive activity, a bulk data transfer, and multimedia communications, among others. If the types of activities are determined to be the same, the activity detector 830 may determine to ignore the newly detected indication 935′ in advance of the activity 940′. The activity detector 830 may also discard the detected indication 935′ from additional processing by the buffer scaling service 805. On the other hand, if the types of activities 940 and 940′ are determined to be different, the activity detector 830 may determine to further process newly detected indication in advance of the activity 940′. The type of the activity 940′ may potentially be used to determine a new scale 920″ for configuring the number of buffers 845 to provide for the session 905.

The adaptive scaler 835 may calculate, identify, or otherwise determine at least one scale 920″ based on the round trip time 915′. The determination of the scale 920″ may be similar to the determination of the scale 920 as detailed herein above. The determination of the scale 920″ may be based on the measurements of round trip time 915′, such as the instantaneous round trip time or the aggregate round trip time. To determine the scale 920″, the adaptive scaler 835 may calculate, generate, or otherwise determine a deviation of the round trip time 915′ from at least one reference value. The reference value may identify an expected value for the round trip time 915′. The reference value may be pre-determined or set based on network metrics from other sessions. The deviation may identify or correspond to a difference between the round trip time 915′ and the reference value.

With the determination, the adaptive scaler 835 may compare a deviation of round trip time 915′ from the reference value to at least one threshold. The threshold may delineate, define, or otherwise identify a value for the round trip time 915′ at which to adjust (e.g., increase or decrease) or maintain the number of buffers 845 to provide for the session 905. The threshold may also be used to determine the number of buffers 845 to provide based on the round trip time 915′. In some embodiments, the adaptive scaler 835 may compare the deviation of the round trip time 915′ with a set of thresholds. Each threshold may identify a value for the round trip time 915′ at which to increase or decrease the number of buffers 845 by a corresponding scale 920″. In general, the greater the deviation, the more likely that number of buffers 845 may be adjusted by increasing or decreasing.

Based on the comparison of the deviation, the adaptive scaler 835 may determine the scale 920″ to set the number of buffers 845 to provide. In determining, the adaptive scaler 835 may determine whether the deviation exceeds the threshold. If the deviation of the round trip time 915′ exceeds the threshold, the adaptive scaler 835 may determine the scale 920″ to decrease the number of buffers 845 to provide. The scale 920″ may be, for instance, a multiplicative factor less than 1 to decrease the number of buffers 845 to provide for the session 905. On the other hand, if the deviation of the round trip time 915′ does not exceed the threshold, the adaptive scaler 835 may determine the scale 920″ to increase the number of buffers 845 to provide. The scale 920″ may be, for instance, a multiplicative factor less than or equal to 1 to decrease or maintain the number of buffers 845 to provide for the session 905. In some embodiments, the adaptive scaler 835 may determine the scale 920″ to maintain the number of buffers 845 provided to the session 905.

If the other activity 940′ is detected and determined to be of a different type, the adaptive scaler 835 may identify or select which activity (e.g., the activity 940 or 940′) is to be used for the determination of the scale 920″. The selection of the activity to use may be in accordance with priorities for the activities (e.g., as defined by the policy), and may be similar to the selection of the activity 940 using the policy as discussed above in the process 930. In some embodiments, from the identified activities, the adaptive scaler 835 may select the activity to be performed in the foreground process in accordance with the policy. The activity associated with the foreground process may be assigned the highest priority by the policy. In some embodiments, the adaptive scaler 835 may identify a corresponding priority for each activity (the activity 940 or 940′) as defined by the policy. Based on the priorities, the adaptive scaler 835 may select the activity to use in determining the scale 920″.

With the selection, the adaptive scaler 835 may compare the type of the activity with the type of the activity 940. The selection in accordance with the priorities may result in an activity (e.g., the activity 940′) different from the previously identified activity 940. If the types of activities are determined to be the same, the adaptive scaler 835 may determine to ignore the newly detected indication in advance of the activity 940′. The adaptive scaler 835 may also discard the detected indication from additional processing by the buffer scaling service 805. On the other hand, if the types of activities are determined to be different, the adaptive scaler 835 may determine to use the type of the activity 940′ to determine a new scale 920″ (e.g., as discussed in process 930) for configuring the number of buffers 845.

The buffer manager 840 may configure, assign, or otherwise set the number of buffers 845 to provide to the session 905 in accordance with the determined scale 920″. The setting of the number of buffers 845 to provide based on the scale 920″ may be similar to the setting of the number of buffers 845 using the scale 920 as discussed above. Upon determining the scale 920″, the buffer manager 840 may find or identify the current set of buffers 845 assigned to the session 905. When the scale 920″ is to decrease the number of buffers 845 (e.g., as with bulk data transfer), the buffer manager 840 may disassociate, take away, or otherwise remove a subset of the buffers 845 from the session 905. The subset of buffers 845 to be removed may be in accordance with the scale 920″.

When the scale 920″ is to increase the number of buffers 845 (e.g., as with user interactive activity), the buffer manager 840 may augment, supplement, or otherwise assign additional buffers 845 for the session 905. The buffers 845 to be added for the session 905 may be in accordance with the scale 920″. The buffer manager 840 may find, select, or otherwise identify buffers 845 available for the session 905, such as buffers 845 not assigned to any other sessions 905 with the server 106 or over the appliance 200. With the identification, the buffer manager 840 may identify a subset of buffers 845 to assign to the session 905 based on the scale 920″ and the number of buffers 845 currently assigned to the session 905. Once identified, the buffer manager 840 may assign the subset of buffers 845 to the session 905.

In some embodiments, the buffer manager 840 may provide, send, or otherwise transmit information on the number of buffers 845 provided for the session 905 to another instance of the buffer manager 840. The information may identify or include the scale 920″, the number of buffers 845 provided for the session 905, and an amount of change in the number of buffers 845, among others. The buffer manager 840 in turn may also configure or set the number of buffers 845 on the appliance 200 in accordance with the information provided by the buffer manager 840 on the server 106 (e.g., the scale 920″ determined based on the type of the activity 940). The setting of the number of buffers 845 on the appliance 200 using the scale 920″ may be in a similar manner as the setting of the number of buffers 845 using the scale 920″ as discussed above.

Referring now to FIG. 9D, depicted is a block diagram of a process 980 of scaling buffers in response to indications of termination of activities (e.g., the activity 940 or 940′) in the system 800 for determining scales. The process 980 may correspond to or include operations performed in the system 800 for determining scales in advance of the end with the occurrence of the detected events as discussed in conjunction with the process 960 above. Under the process 980, the session monitor 825 may calculate, determine, or otherwise identify at least one round trip time 915″ (also referred herein as an instantaneous round trip time) of the session 905 for the client 102. The identification of the round trip time 915″ may be similar to the identification of the round trip time 915 as detailed herein above. In continuing to measure, the session monitor 825 may calculate a difference in the time at which a packet is sent from one end and the time at which a response from the other end is received to use as the round trip time 915″.

In some embodiments, the session monitor 825 may determine the aggregate round trip time 915″ using a set number of round trip times 915″ (e.g., 5 to 15 round trip time measurements). The determination of the aggregate round trip time 915″ may be similar to the determination of the aggregate round trip time 915 as discussed herein above. The determination of the aggregate round trip time 915″ may be based on a function of the acquired round trip times 915″, such as a moving average, weighted moving average, an exponential moving average, or smoothing function, or any combination thereof among other. The aggregate round trip time 915″ may be used to configure or set the number of buffers 845 to provide for the session 905. In some embodiments, the session monitor 825 may identify other characteristics regarding the session 905, besides the round trip time 915″ for determining a scale to set the buffers 845 for the session 905, in a similar manner as discussed above. The characteristics may include network metrics of the session 905, measurements from other sessions, and the process on which the previously identified activity 940, among others.

The activity detector 830 may check or otherwise monitor for at least one indication 935″ in advance of the end of the previously identified activity 940 on the client 102 to access through the session 905. The monitoring and detection of the indication 935″ may be similar to the monitoring and detection of the indication 935 as discussed above. In addition, the indication 935″ may also be sent from the server 106 (e.g., or the server-side agent 815) to the appliance 200, in a similar manner as discussed above with respect to the indication 935. The indication 935″ may be in advance of the end of the activity 940 at least partially concurrently performed on the client 102. The indication 935″ (sometimes herein referred to a hints) may identify, include, or otherwise correspond to any interactions, function invocations, or communications, or any combination thereof, correlated with, corresponding to, or otherwise associated with the activity 940. The depicted example focuses on the detecting the indication 935″ prior to the end of the activity 940.

To monitor for the indication 935″, the activity detector 830 may use one or more event listeners within the session 905 (e.g., in the virtual desktop 910 or applications accessed therein). The monitoring using the event listeners may be similar to the discussion in process 930. At least one event listener provided for the session 905 may monitor for a defined set of user interactions or function calls associated with the end of a corresponding type of activity 940, in conjunction with the occurrence of the activity 940. Upon invocation, the event listener may convey, provide, or otherwise send the indication 935″ to the buffer scaling service 805. The indication 935″ may identify the type of activity 940 based on the user interactions. The indication 935″ may also identify that the identification of the activity 940 is prior to the end of the activity 940. With receipt, the activity detector 830 may in turn detect the indication 935″ in advance of the end of the activity 940.

In some embodiments, the activity detector 830 may receive, intercept, or otherwise identify communications (e.g., packets) in the session 905 to monitor for the indication 935″ in advance of the end of the activity 940. With the identification, the activity detector 830 may compare the communications with a set of rules. Each rule may specify or define a pattern of communications associated with a corresponding type of activity 940. Certain patterns in the communications within the session 905 may be associated with the end of the activity 940. When the communications does not match with any of the rules for end of a corresponding activity 940, the activity detector 830 may refrain from detecting the indication 935″, and may continue to monitor. Conversely, when the communications matches with a rule for an end of a corresponding activity 940, the activity detector 830 may determine or detect the indication 935″ in advance of the end of the activity 940 corresponding to the rule. In addition, the activity detector 830 may identify that the identification of the activity 940 is in advance of the end of the occurrence of the activity 940 (e.g., as depicted).

With detection of the indication 935″, the activity detector 830 may identify or otherwise determine the type of the activity 940. As the indication 935′″ is for the same activity 940 as previously identified, the type of the activity 940 may also be the same. When the indication 935″ is associated with the user interactive activity (or interactive type), the activity detector 830 may determine that the type of activity 940 is user interactive activity. When the indication 935″ is associated with a bulk data transfer (or non-interactive type), the activity detector 830 may determine that the type of activity 940 is bulk data transfer. When the indication 935″ is associated with multimedia communications (or mixture), the activity detector 830 may determine that the type of activity 940 is for multimedia communications.

The adaptive scaler 835 may calculate, identify, or otherwise determine at least one scale 920′″ in accordance with the type of the activity 940 and the round trip time 915′. The determination of the scale 920′″ may be similar to the determination of the scale 920 as detailed herein above. The determination of the scale 920′″ may be based on the measurements of round trip time 915′″, such as the instantaneous round trip time or the aggregate round trip time. To determine the scale 920′″, the adaptive scaler 835 may calculate, generate, or otherwise determine a deviation of the round trip time 915″ from at least one reference value. The reference value may identify an expected value for the round trip time 915″. The reference value may be pre-determined or set based on network metrics from other sessions. The deviation may identify or correspond to a difference between the round trip time 915″ and the reference value.

With the determination, the adaptive scaler 835 may compare a deviation of round trip time 915′″ from the reference value to at least one threshold. The threshold may delineate, define, or otherwise identify a value for the round trip time 915′″ at which to adjust (e.g., increase or decrease) or maintain the number of buffers 845 to provide for the session 905. The threshold may also be used to determine the number of buffers 845 to provide based on the round trip time 915′″. In some embodiments, the adaptive scaler 835 may compare the deviation of the round trip time 915″ with a set of thresholds. Each threshold may identify a value for the round trip time 915″ at which to increase or decrease the number of buffers 845 by a corresponding scale 920′″. In general, the greater the deviation, the more likely that number of buffers 845 may be adjusted by increasing or decreasing.

Based on the comparison of the deviation and the type of the activity 940, the adaptive scaler 835 may determine the scale 920′″ to set the number of buffers 845 to provide. When the type of the activity 940 is the user interactive activity (or interactive), the adaptive scaler 835 may determine whether the deviation exceeds the threshold. If the deviation of the round trip time 915′″ exceeds the threshold, the adaptive scaler 835 may determine the scale 920′″ to increase the number of buffers 845 to provide. The scale 920′″ may be, for instance, a multiplicative factor greater than 1 to increase the number of buffers 845 to provide for the session 905. On the other hand, if the deviation of the round trip time 915′″ does not exceed the threshold, the adaptive scaler 835 may determine the scale 920′″ to decrease the number of buffers 845 to provide. The scale 920′″ may be, for instance, a multiplicative factor less than 1 to decrease the number of buffers 845 to provide for the session 905.

When the type of the activity 940 is the bulk data transfer (or non-interactive), the adaptive scaler 835 may determine whether the deviation exceeds the threshold. If the deviation of the round trip time 915′″ exceeds the threshold, the adaptive scaler 835 may determine the scale 920′″ to decrease the number of buffers 845 to provide. The scale 920′″ may be, for instance, a multiplicative factor less than 1 to decrease the number of buffers 845 to provide for the session 905. On the other hand, if the deviation of the round trip time 915′″ does not exceed the threshold, the adaptive scaler 835 may determine the scale 920′″ to increase the number of buffers 845 to provide. The scale 920′″ may be, for instance, a multiplicative factor greater than 1 to increase the number of buffers 845 to provide for the session 905.

When the type of the activity 940 is the multimedia communications, the adaptive scaler 835 may using a number of factors as discussed above. The factors may include, for example, the network metrics of the session 905, the characteristics of the data (e.g., frame rate of the content to be rendered) communicated via the session 905, and measurements from other sessions 905 (e.g., also with multimedia communications), among others. In some embodiments, the adaptive scaler 835 may identify the scale 920′″ as defined by the policy for given set of factors when the detected indication 935″ is for multimedia communications.

The buffer manager 840 may configure, assign, or otherwise set the number of buffers 845 to provide to the session 905 in accordance with the determined scale 920′″. The setting of the number of buffers 845 to provide based on the scale 920′″ may be similar to the setting of the number of buffers 845 using the scale 920 as discussed above. Upon determining the scale 920′″, the buffer manager 840 may find or identify the current set of buffers 845 assigned to the session 905. When the scale 920′″ is to decrease the number of buffers 845 (e.g., as with bulk data transfer), the buffer manager 840 may disassociate, take away, or otherwise remove a subset of the buffers 845 from the session 905. The subset of buffers 845 to be removed may be in accordance with the scale 920′″.

When the scale 920′″ is to increase the number of buffers 845 (e.g., as with user interactive activity), the buffer manager 840 may augment, supplement, or otherwise assign additional buffers 845 for the session 905. The buffers 845 to be added for the session 905 may be in accordance with the scale 920′″. The buffer manager 840 may find, select, or otherwise identify buffers 845 available for the session 905, such as buffers 845 not assigned to any other sessions 905 with the server 106 or over the appliance 200. With the identification, the buffer manager 840 may identify a subset of buffers 845 to assign to the session 905 based on the scale 920′″ and the number of buffers 845 currently assigned to the session 905. Once identified, the buffer manager 840 may assign the subset of buffers 845 to the session 905.

In some embodiments, the buffer manager 840 may provide, send, or otherwise transmit information on the number of buffers 845 provided for the session 905 to another instance of the buffer manager 840. The information may identify or include the scale 920′″, the number of buffers 845 provided for the session 905, and an amount of change in the number of buffers 845, among others. The buffer manager 840 in turn may also configure or set the number of buffers 845 on the appliance 200 in accordance with the information provided by the buffer manager 840 on the server 106 (e.g., the scale 920′″ determined based on the type of the activity 940). The setting of the number of buffers 845 on the appliance 200 using the scale 920′″ may be in a similar manner as the setting of the number of buffers 845 using the scale 920′″ as discussed above.

The activity detector 830 may monitor for the end of activity 940 on the client 102 to access through the session 905. The end of the activity 940 may be detected, while the number of buffers 845 are provided in accordance with the scale 920′″ as determined. The monitoring for and detection of the end of the activity 940 may be similar to the monitoring for and detection of the indication 935, 935′, or 935″ in advance of the activity 940 as detailed herein above. After the end of the occurrence of the activity 940, the buffer manager 840 may continue to adjust, update, or otherwise reset the number of buffers 845 to provide for the session 905 (e.g., in a similar manner as the process 900). The subsequent setting of the number of buffers 845 for the session 905 may be similar as discussed above. For example, the session monitor 825 may identify a new round trip time 915′″ (e.g., instantaneous or aggregated) for the session 905. Using the new round trip time 915′″, the adaptive scaler 835 may determine a new scale 920′″ to increase, decrease, or maintain the number of buffers 845 for the session 905. In accordance with the scale 920′″, the adaptive scaler 835 may set the number of buffers 845 to assign for communications of the session 905. These process 900, 930, 960, and 980 may be repeated any number of times throughout the duration of the session 905.

In this manner, the performance of the session 905 may be improved by the buffer scaling service 805 from detecting the indication 935 or 935′ of activities 940 to occur in advance of the start or the end of occurrence of the activity 940. The number of buffers 845 provided for the session 905 may be scaled up or down by the buffer scaling service 805 for short-term activities to optimize network throughput to make the activity efficient during the time. A layer of reliability over the transport can utilize the optimization process to improve the performance for selective phases of the session 905.

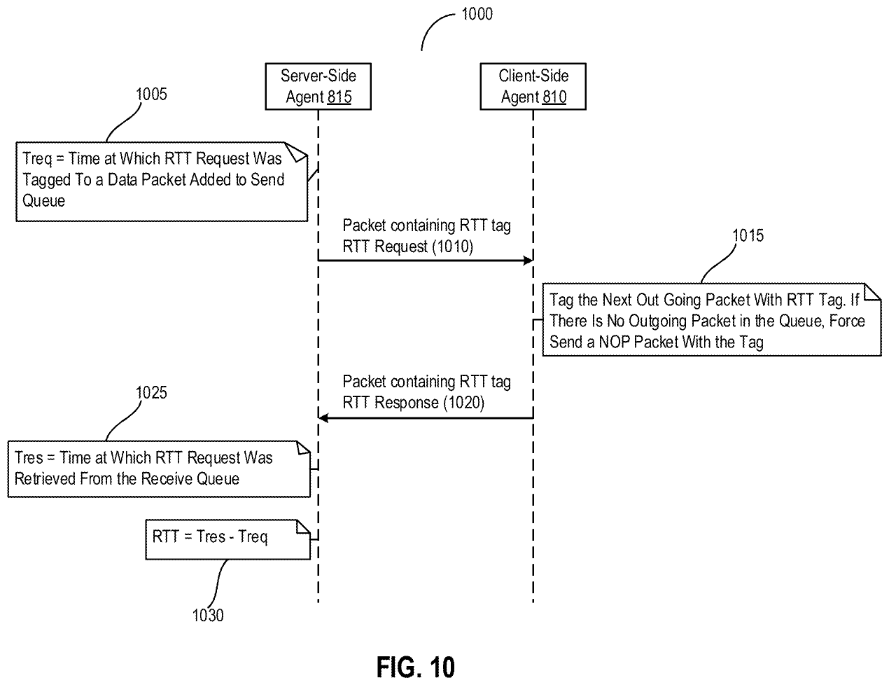

Referring now to FIG. 10, depicted is a communication diagram of a process 1000 for determining scales for buffers for sessions between a server-side agent 815 and a client-side agent 810. The functionalities of process 1000 may be implemented using, or performed by, the components described in FIGS. 1-9D, such as the client 102, the server 106, or the appliance 200. As depicted, the server-side agent 815 may identify a time (T req) as a time at which a round trip time request was tagged to a data packet added to a send queue (1005). The server-side agent 815 may send the packet containing the tag for the round trip time request to the client-side agent 810 (1010). The client-side agent 810 may tag the next outgoing packet with the round trip time tag (1015). If there is no outgoing packet in the queue, the client-side agent 810 may force the sending of a packet (e.g., no-operation (NOP) packet) with the round trip time tag to the server-side agent 815. The client-side agent 810 may send the packet with the round trip time tag as the round trip time response to the server-side agent 815 (1020). The server-side agent may identify a time (Tᵣₑₛₚ) as a time at which the round trip time request was retrieved from the receive queue (1025). The server-side agent 815 may determine the round trip time as the difference between time (T_{req}) and time (Tᵣₑₛₚ) (1030).

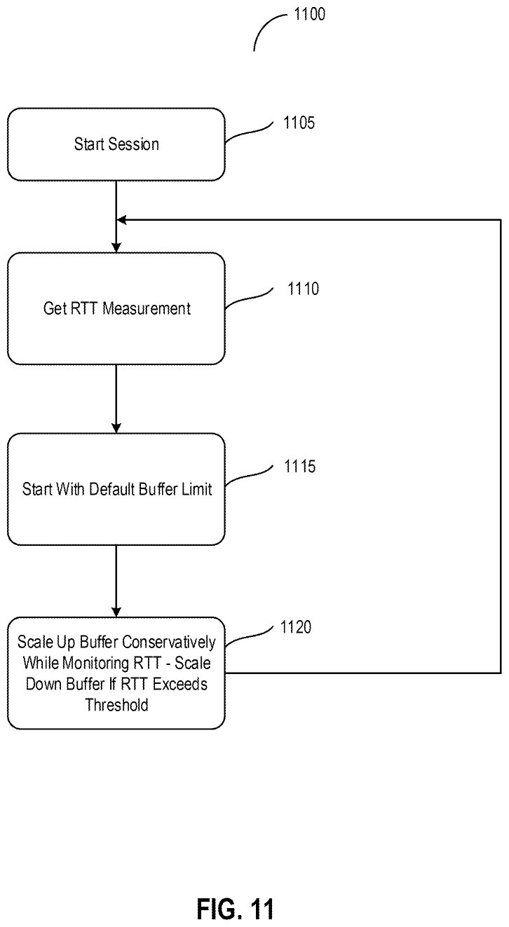

Referring now to FIG. 11, depicted is a flow diagram of a method 1100 of determining scales for buffers for sessions prior to detecting activities on clients. The functionalities of method 1100 may be implemented using, or performed by, the components described in FIGS. 1-9D, such as the client 102, the server 106, or the appliance 200. Under the method 1100, a session (e.g., the session 905) may be started between a client (e.g., the client 102) and a server (1105).

A round trip time (RTT) measurement may be obtained (1110). As for the metrics used, interactivity may be determined by tagging an outgoing packet in the processing stack of the server (e.g., on a layer below virtual channels) for a round-trip time (RTT) measurements. The packet may be timed after being tagged (T_{req}). The packet may travel through the stack and network drives and may reach the client. When the packet is received by the client, a response packet may be sent by the client by tagging the packet with the same tag. If there are additional packets to be sent to the server, one of these packets may be tagged and sent back. On the other hand, if there are no packets to be sent from the client, the client may sent a no-operation (NOP) packet (e.g., ICA layer NOP) back to the server with the RTT tag. The server may compute the time of reception of the packet with the tag (Tᵣₑₛₚ). The time difference between the two (Tᵣₑₛₚ−T_{req}) may be the round-trip time taken for a packet to reach the destination, to be processed and to be sent back. This may be an estimated measurement of interactivity.

A default number of buffers may be provided to start with for the session (1115). The stack, upon session launch, may start with a default number of buffers (determined as a good starting point through internal testing) to start. It may wait for 10 consecutive values of RTT and computes an exponentially weighted average (EWMA) of RTT values and maintains the EWMA of the RTT values (wRTT). A default RTT threshold (tRTT) may be set on the virtual desktop provider (e.g., determined through testing and customer feedback). This default value can be modified via policies.

Afterward, measurement of an instantaneous round trip time (iRTT) may be triggered once every second and the stack makes sure that there is not more than one active RTT measurement at any given time. UpdateRtt may compute wRTT using consecutive iRTT values. It also may take care of eliminating outliers (less than 3 consecutive iRTT values that are greater than threshold). If there are more than 3 consecutive values greater than threshold, the values may be considered valid. If, at any time, running average of 3 iRTT values is greater than the threshold, a warning is returned to the scaling function.

At any point, the number of available buffers may be not modified unless the current number of buffers in use is greater than 80% of the total available buffers. The number of buffers in use may be assumed to be greater than 80% of the total available buffers during the time of scaling in this example.

Once the stack receives more than 10 iRTT values, the initial scaling may begin (1120). The aggressiveness of scaling is determined by the ratio of wRTT vs tRTT. If wRTT is less than 50% of tRTT, buffers are increased aggressively. If wRTT is greater than 50% but less than 75% of tRTT, scaling is done more conservatively. If wRTT is more than 75% of threshold, a default minimum value (conservatively minimum determined by testing) is assumed for number of buffers. If wRTT is greater than tRTT, an absolute minimum (determined by testing) is assumed for number of buffers.

During scaling, after increasing the number of buffers every cycle, the stack may make note of current wRTT as pRTT and wait for 8 consecutive values of iRTT before monitoring wRTT. A warning sign from UpdateRtt is checked upon reception of every iRTT value. Scaling algorithm may reduce the available number of buffers by 50% immediately upon receiving the warning. If no warnings are raised, scaling algorithm scales based on the updated wRTT value. On the first occurrence of reduction of buffers, initial scaling ends. After the initial scaling, the same cycle of modifying number of buffers, waiting for 8 consecutive values of iRTT or a warning from UpdateRtt before going into the next scaling cycle is repeated, though any increase in number of buffers are more conservative compared to the initial scaling cycle. This cycle of modifying (increase/decrease) number of buffers followed by waiting for 8 consecutive values of iRTT or warning from UpdateRtt constitutes as scaling cycle. The scaling cycle repeats throughout the session (unless disabled by policy).

The subsequent scaling cycles after initial scaling conservatively may increase the number of buffers in comparison with the initial scaling. After every scaling cycle, the wRTT is compared with pRTT (including a delta for margin of error—the value of delta is determined upon testing and is a constant value). pRTT value is not updated if buffers are increased conservatively every time to prevent high latencies due to accumulation of margin for error (delta) that is considered in the above step. When wRTT value starts to increase beyond the margin for error, number of buffers are scaled down conservatively and the process is repeated to maintain the optimal value of number of buffers and thereby maintaining an optimal value of throughput. The throughput of the session may be adjusted to reflect the changes in the use case or the network dynamically.

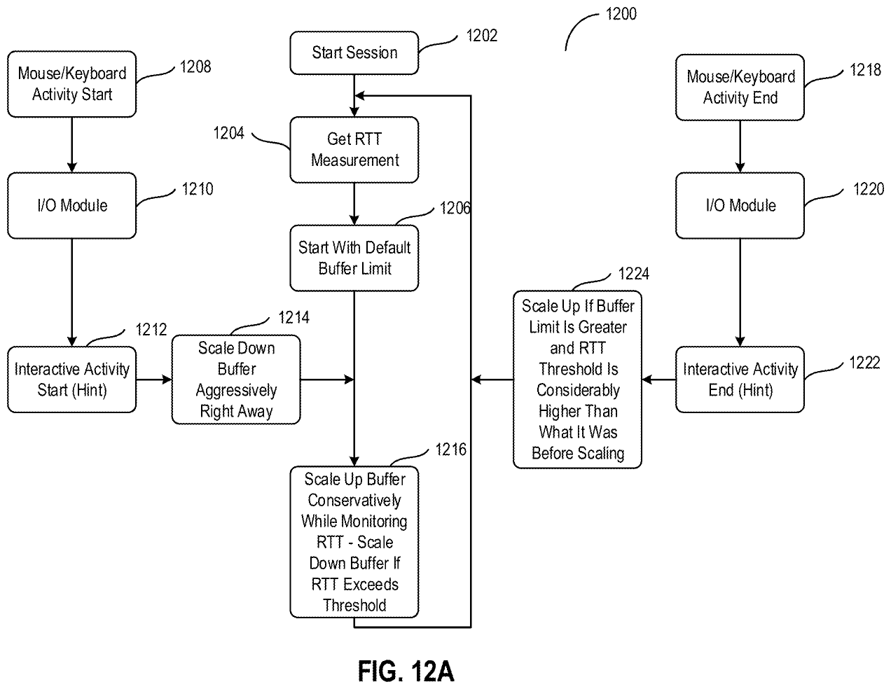

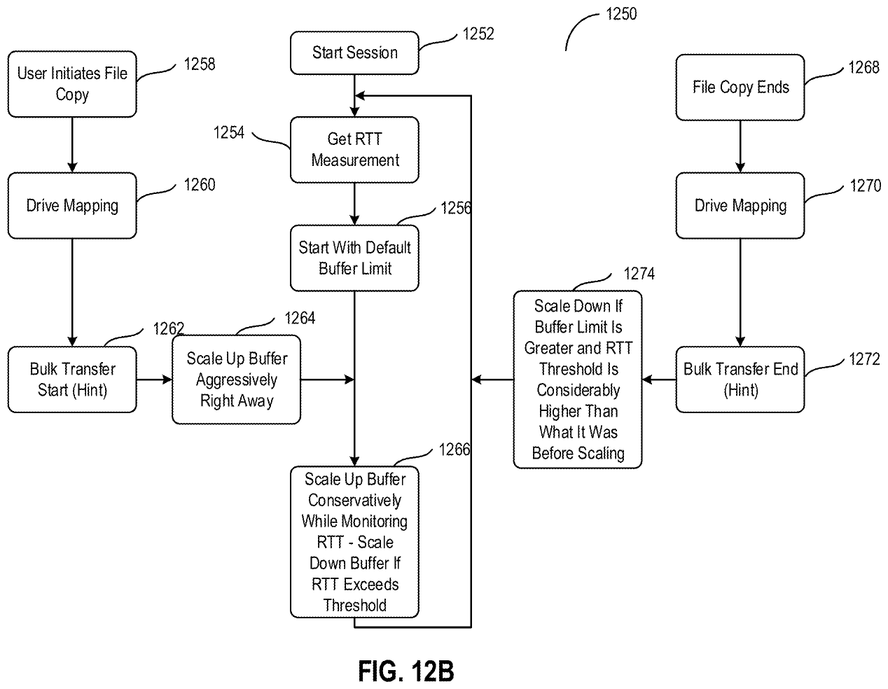

Referring now to FIG. 12A, depicted is a flow diagram of a method 1200 of determining scales for buffers for sessions when detecting an indication of a user interactive activity. The functionalities of method 1200 may be implemented using, or performed by, the components described in FIGS. 1-9D, such as the client 102, the server 106, or the appliance 200. Under the method 1200, a session (e.g., the session 905) may be started (1202). A round trip time (RTT) measurement (e.g., the round trip time 915) may be obtained (1204). A default number of buffers may be provided to start with for the session (1206).

The stack may monitor for hints in advances of the start of interactive activities (1208). The stack may use an input/output (I/O) module to monitor the hints (1210). Interactivity hints can be detected by a combination of different parameters, such as speed or frequency of scrolling, touch input, keyboard activity, and moving of windows around. By monitoring the combination of these activities, hints can be provided to the stack (1212). Once the stack receives these hints, the stack may scale down the number of buffers quickly to facilitate the interactivity of the session (1214). This results in decreased throughput and hence more interactive response.

The stack may continue to measure the round trip time to determine whether to scale up or down the buffers (1216). If the buffers are already scaled for optimal throughput, which can be determined by the average RTT that is being observed in the session, stack may not scale down the buffers. Once the operation is ended, hints would be received from a combination of the above-mentioned parameters. The stack may monitor for the end of the interactive activities from interactions with mouse, keyboards, or input/output (I/O) devices (1218). The stack may retrieve hints from the I/O module (1220). The stack may be provided with the hint (1222). ICA stack, upon the reception of these hints, may scale the buffers back to the pre-scaled values (1224).

Referring now to FIG. 12B, depicted is a flow diagram of a method 1250 of determining scales for buffers for sessions when detecting an indication of a bulk data transfer. The functionalities of the method 1250 may be implemented using, or performed by, the components described in FIGS. 1-9D, such as the client 102, the server 106, or the appliance 200. Under the method 1250, a session (e.g., the session 905) may be started (1252). A round trip time (RTT) measurement (e.g., the round trip time 915) may be obtained (1254). A default number of buffers may be provided to start with for the session (1256).

The stack may monitor for hints in advances of the start of file copy activities (1258). The stack may use a drive mapping module to monitor the hints (1260). Bulk data transfer can be detected using hooks and events. For example, a file copy from the server to the client device may be a form of bulk data transfer. Starting of a file copy operation can be detected by a drive mapping module. This module can then inform the stack about the beginning of bulk transfer operation (1262). Once the stack receives these hints, the stack may scale up the number of buffers quickly to facilitate the bulk data transfer (1264).

The stack may continue to measure the round trip time to determine whether to scale up or down the buffers (1266). If the buffers are already scaled for optimal throughput, which can be determined by the average RTT that is being observed in the session, stack shall not scale up the buffers. The stack may monitor for the end of the bulk data transfer activities from interactions with drive mapping module (1268). The stack may retrieve hints from the drive mapping module (1270). Once the operation is ended, the drive module may indicate the end of operation to the ICA stack and the buffers are scaled down (1272).

This results in increased throughput and faster file transfer. File copies may happen once. Taking time to scale up even though may provide for a better average over 5 file copies, consuming a significant amount time for the first copy to complete. Getting a hint ahead of time for bulk transfers and scaling up quickly may improve the transfer times from the very beginning of the transfer itself. The scaling may further provide better average over time as well as reduce the scaling time to optimal throughput.

In addition, the stack may monitor for mixed hints. There can be scenarios where both interactive and file copy hints can arrive concurrently. An arbitration may be needed when there are multiple concurrent hints. For example, if both bulk transfer and interactive activity hints are received together, by default, interactive activity is given preference over bulk transfer in accordance with a policy. If the interactive operation slows down (based on speed or frequency of the activity and user idle times) before bulk transfer operation, completion of interactive activity hints may be received and buffers may be increased to facilitate bulk transfer operation until a bulk transfer completion hint is received. The stack then may then back to pre-scaling values of buffers and continues to monitor the metrics.

In case of video playback, which may be a combination of both interactive and non-interactive nature, the scaling may be performed to facilitate video quality while maintaining smooth playback. In this case, the stack may find a balance that facilitates video playback. In this case, when there is an app in the foreground playing video, the buffers may be scaled to an ideal value. The scaling may be based on a number of factors, such as bandwidth, delay product of the network, and the framerate for the video along with statistical measurements from other deployments similar to the current conditions.

In some embodiments, the stack may use policy-based hints. The policy may be configured by the administrator and may specify, for example: (1) ignoring the hints from the system and favor bulk transfer; (2) ignoring the hints from the system and favor interactivity; (3) ignoring the hints from the system and continue to use the existing scaling algorithm; or (4) disabling the adaptive scaling and statically set the number of buffers, among others. The policy may limit bandwidth usage for a particular activity (e.g., limiting bandwidth usage for bulk data transfer Virtual Channel) or for a particular session can also be taken into consideration as hints while scaling the buffers.

Buffers can be scaled based on the type of application resource being launched and the type of application that is in the foreground during the session. If the application is of bulk transfer nature, the nature of the bulk data transfer can be used to facilitate faster transfers and vice versa. If the application is of interactive activity in nature, the nature of the interactive activity can be used to facilitate interactivity. The hints may work in conjunction with the scaling algorithm in deciding on whether to scale the buffers or not. If an interactive activity hint is received and the current state of the scaling algorithm favors interactivity, the stack may refrain from scaling. Similarly, if the bulk data transfer hint is received and the current state of the scaling algorithm favors bulk transfer, the stack may refrain from scaling.

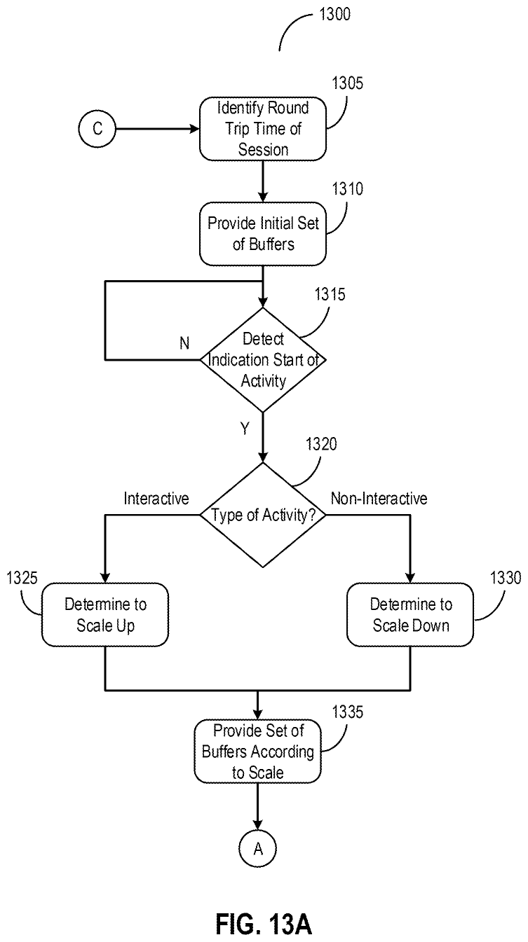

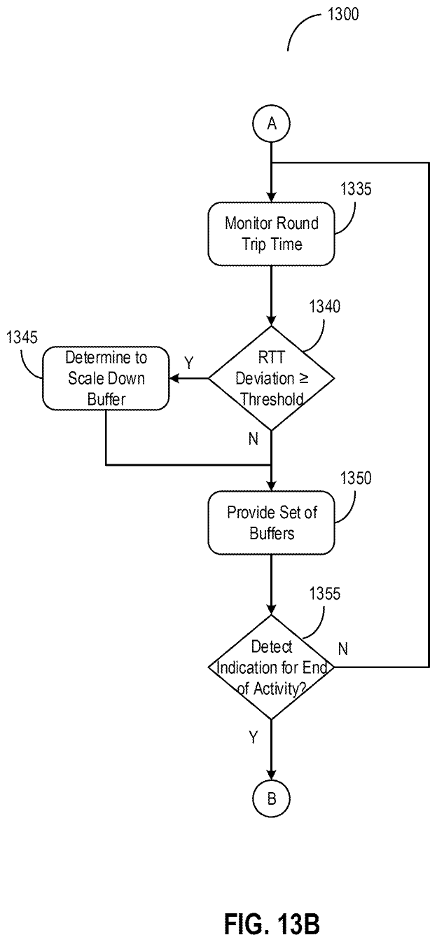

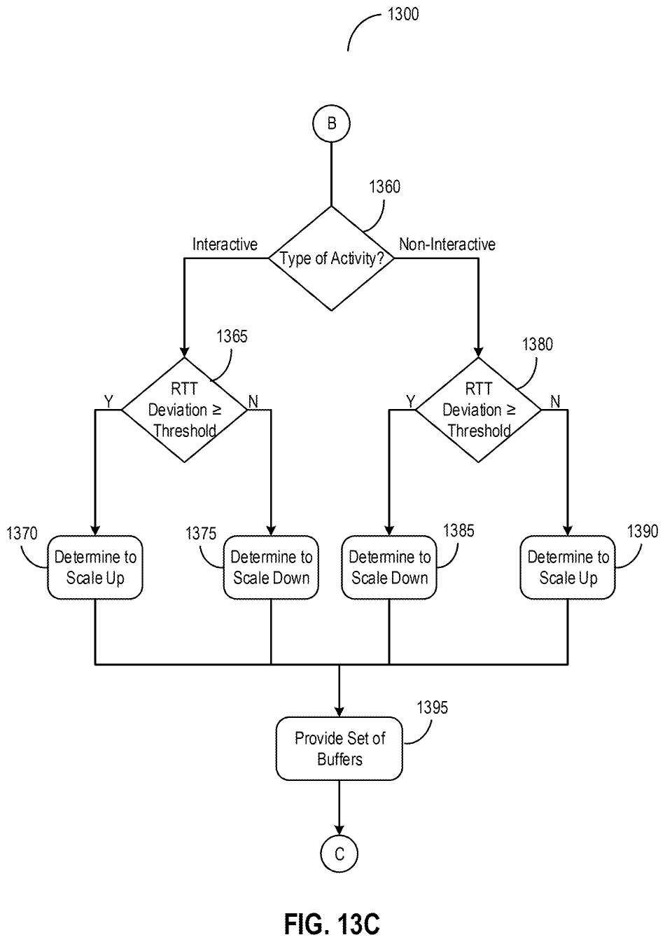

Referring now to FIGS. 13A-C, depicted are flow diagrams of a method 1300 of determining scales for buffers for sessions in accordance with an illustrative embodiment. The functionalities of method 1300 may be implemented using, or performed by, the components described in FIGS. 1-9D, such as the client 102, the server 106, or the appliance 200. Starting from FIG. 13A, under the method 1300, a device (e.g., the buffer scaling service 805) may identify a round trip time (e.g., the round trip time 915) of a session (e.g., the session 905) (1305). The device may provide an initial set of buffers (e.g., the buffers 845) based on the round trip time (1310). The device may monitor for an indication (e.g., the indication 935) of a start of an activity (e.g., the activity 940) (1315). If not detected, the device may continue to monitor for the indication. Otherwise, if detected, the device may identify a type of activity (1320). When the type of activity is interactive, the device may determine to scale up (e.g., the scale 920′) (1325). On the other hand, when the type of activity is non-interactive, the device may determine to scale down (1330). The device may provide the set of buffers in accordance with the scale (1335).

Continuing on to FIG. 13B, the device may monitor a round trip time (e.g., the round trip time 915′) for communications in the session subsequent to the scaling (1335). The device may determine whether a deviation of the round trip time from a reference value is greater than or equal to a threshold (1340). If the round trip times is greater than or equal to the threshold, the device may determine to scale down (e.g., the scale 920″) (1345). In any event, the device may provide the set of buffers in accordance with the scale (1350). The device may detect an indication for an end of the activity (1355). If not detected, the device may continue to monitor round trip time and repeat operations from (1335)—(1355).

Moving to FIG. 13C, if the end of the activity is detected, the device may identify the type of activity (1360). When the type of activity is interactive, the device may determine whether a deviation of the round trip time from a reference value is greater than or equal to the threshold (1365). If the deviation of the round trip time is greater than or equal to the threshold, the device may determine to scale up (e.g., the scale 920′″) (1370). Otherwise, if the deviation of the round trip time is less the threshold, the device may determine to scale down (1375). Conversely, when the type of activity is non-interactive, the device may determine whether a deviation of the round trip time from the reference value is greater than or equal to the threshold (1380). If the deviation of round trip time is greater than or equal to the threshold, the device may determine to scale down (1385). Otherwise, if the deviation of the round trip time is less the threshold, the device may determine to scale up (1390). With the determination of the scale, the device may provide the set of buffers for the session (1395). The device may repeat the operations from (1305) an onward, throughout the duration of the session.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

It will be further understood that various changes in the details, materials, and arrangements of the parts that have been described and illustrated herein may be made by those skilled in the art without departing from the scope of the following claims.

We claim:

1. A method of determining a scale for buffers of a session, comprising:
identifying, by a device, a round trip time (RTT) of a session of a client for which one or more of a plurality of buffers are provided;
detecting, by the device, an indication in advance of an activity on the client to access through the session;
determining, by the device responsive to detecting the indication, a scale based at least on a type of the activity; and
setting, by the device, a number for the plurality of buffers to be provided for the session in accordance with the scale and the RTT.

2. The method of claim 1, wherein detecting the indication further comprises detecting the indication in advance of a start of a user interactive activity on the client, and
wherein determining the scale further comprises determining the scale to decrease the number of the plurality of buffers to provide.

3. The method of claim 1, wherein detecting the indication further comprises detecting the indication in advance of an end of a user interactive activity on the client, and
wherein determining the scale further comprises determining the scale to increase the number of the plurality of buffers to provide, responsive to a deviation of the RTT from a reference value exceeding a threshold.

4. The method of claim 1, wherein detecting the indication further comprises detecting the indication in advance of a start of a bulk data transfer through the session, and
wherein determining the scale further comprises determining the scale to increase the number of the plurality of buffers to provide.

5. The method of claim 1, wherein detecting the indication further comprises detecting the indication in advance of an end of a bulk data transfer through the session, and
wherein determining the scale further comprises determining the scale to decrease the number of the plurality of buffers to provide, responsive to a deviation of the RTT from a reference value exceeding a threshold.

6. The method of claim 1, wherein detecting the indication further comprises detecting the indication in advance of a plurality of activities on the client, and further comprising
identifying, by the device, from the plurality of activities, the activity to be performed in a foreground process, and
wherein determining the scale further comprises determining the scale in accordance with the type of the activity to be performed in the foreground process.

7. The method of claim 1, wherein detecting the indication further comprises detecting the indication in advance of a plurality of activities on the client, and
identifying, by the device, from the plurality of activities, the activity to be performed in a foreground process and a second activity to be performed in a background process, and
wherein determining the scale further comprises determining the scale in accordance with a policy identifying a plurality of priorities for the foreground process and the background process.

8. The method of claim 1, wherein detecting the indication further comprises detecting the indication in advance of multimedia communications via the client; and
wherein determining the scale further comprises determining the scale using at least one of: a network metric of the session, characteristics of content in the multimedia communications, or measurements from a plurality of sessions with multimedia content.

9. The method of claim 1, further comprising modifying, by the device, between a start and an end of the activity, the number of the plurality of buffers to provide to the session in accordance with a comparison of the RTT with a threshold.

10. The method of claim 1, further comprising determining, by the device responsive to detecting the indication, whether to set the number of the plurality of buffers based at least on the RTT of the session.

11. A system for determining a scale for buffers of a session, comprising:
a device having one or more processors coupled with memory, configured to:
identify a round trip time (RTT) of a session of a client for which one or more of a plurality of buffers are provided;
detect an indication in advance of an activity on the client to access through the session;
determine, responsive to detecting the indication, a scale based at least on a type of the activity; and
set a number for the plurality of buffers to be provided for the session in accordance with the scale and the RTT.

12. The system of claim 11, wherein the device is further configured to:
detect the indication in advance of a start of a user interactive activity on the client, and
determine the scale further comprises determining the scale to decrease the number of the plurality of buffers to provide.

13. The system of claim 11, wherein the device is further configured to
detect the indication in advance of an end of a user interactive activity on the client, and
determine the scale to increase the number of the plurality of buffers to provide, responsive to a deviation of the RTT from a reference value exceeding a threshold.

14. The system of claim 11, wherein the device is further configured to
detect the indication in advance of a start of a bulk data transfer through the session, and
determine the scale to increase the number of the plurality of buffers to provide.

15. The system of claim 11, wherein the device is further configured to
detect the indication in advance of an end of a bulk data transfer through the session, and
determine the scale to decrease the number of the plurality of buffers to provide, responsive to the RTT exceeding a threshold.

16. The system of claim 11, wherein the device is further configured to:
detect the indication in advance of a plurality of activities on the client, and
identify, from the plurality of activities, the activity to be performed in a foreground process, and
determine the scale in accordance with the type of the activity to be performed in the foreground process.

17. The system of claim 11, wherein the device is further configured to modify, between a start and an end of the activity, the number of the plurality of buffers to provide to the session in accordance with a comparison of the RTT with a threshold.

18. A non-transitory computer readable medium storing program instructions for causing one or more processors to:
identify a round trip time (RTT) of a session of a client for which one or more of a plurality of buffers are provided;
detect an indication in advance of an activity on the client to access through the session;
determine, responsive to detecting the indication, a scale based at least on a type of the activity; and
set a number for the plurality of buffers to be provided for the session in accordance with the scale and the RTT.

19. The non-transitory computer readable medium of claim 18, wherein the instructions cause the one or more processors to:
detect the indication in advance of a plurality of activities on the client, and
identify, from the plurality of activities, the activity to be performed in a foreground process, and
determine the scale in accordance with the type of the activity to be performed in the foreground process.

20. The non-transitory computer readable medium of claim 18, wherein the instructions cause the one or more processors to modify, between a start and an end of the activity, the number of the plurality of buffers to provide to the session in accordance with a comparison of the RTT with a threshold.
